(19) United States
(12) Patent Application Publication
(10) Pub. No.: US 2025/0053872 A1
(43) Pub. Date: Feb. 13, 2025

(54) MODEL ID-BASED AI/ML MODEL UPDATE MANAGEMENT FRAMEWORK AND ITS USE

(71) Applicant: Nokia Technologies Oy, Espoo (FI)

(72) Inventors: Jerediah FEVOLD, Chicago, IL (US); Endrit DOSTI, Espoo (FI); Muhammad Ikram ASHRAF, Espoo (FI)

(21) Appl. No.: 18/797,512

(22) Filed: Aug. 8, 2024

Related U.S. Application Data
(60) Provisional application No. 63/531,937, filed on Aug. 10, 2023.

(51) Int. Cl. G06N 20/00

(52) U.S. Cl. CPC G06N 20/00

(57) ABSTRACT

A network element evaluates performance of a first AI/ML model being used by a UE. The network element sends, based on the evaluation, configuration to a network entity involved in performing model retuning of the first AI/ML model to aid in the model retuning. The network element monitors and evaluates performance of a second AI/ML model that is a retuned version of the first AI/ML model. The first and second AI/ML models are from a same lineage of AI/ML models. The network element stores, in response to the evaluation of the second AI/ML model, the second AI/ML model for use by other UE(s). A UE receives the configuration, and performs operation(s) to aid in the performing retuning. The retuning creates a second AI/ML model that is a retuned version of the first AI/ML model. The UE switches from the first AI/ML model to the second AI/ML model.

### TECHNICAL FIELD

Examples of embodiments herein relate generally to artificial intelligence (AI) or machine learning (ML) (together, AI/ML) models and their use for communication systems and, more specifically, relate to using multiple models and corresponding retuned models with different identifications (IDs).

### BACKGROUND

Wireless communication systems, in particular cellular systems, are using AI/ML (artificial intelligence/machine learning, so also referred to as AI/ML) models. As is known, an AI/ML model is a data driven algorithm that applies AI/ML techniques to generate a set of outputs based on a set of inputs. Another way to describe this is that AI/ML models use decision-making algorithms to learn from training data and apply that learning to achieve specific pre-defined objectives.

For instance, an AI/ML model could be used for user equipment (UE)-based positioning, where the position of a UE in an area accessible by a cellular network is determined, e.g., in part, by an AI/ML model run by the UE. Basically, the AI/ML model is trained based on certain input data, e.g., measurements on physical layer signaling such as positioning reference symbols (PRSs) and additional information such as ground truth labels to produce (via inference) an output of a location estimate. Then, the UE inputs its measurement data to the (previously trained) AI/ML model, which produces an output of its location estimate. It is noted that, in one UE-based method, this is correct. In another, the AI/ML model is used to produce an intermediate output that is provided to a non-AI/ML algorithm to produce the final position estimate.

Recent discussions about these AI/ML models involve how these models can be trained, managed, and stored. Model management includes evaluating performance of the model and providing feedback or even issuing retraining requests to update the model. The model management may also provide model selection or (de) activation or switching or fallback (e.g., to no model) depending, e.g., on the evaluation of the performance of the model. The discussions also involve how these AI/ML models, including updated AI/ML models, can be acquired by the elements in the network, such as the UE, so the element can use the AI/ML models for inference.

### BRIEF SUMMARY

This section is intended to include examples and is not intended to be limiting.

In an exemplary embodiment, a method is disclosed that includes evaluating, by a network element in a wireless network, performance of a first artificial intelligence or machine learning model being used by a user equipment in the wireless network; sending, by the network element based on the evaluation, configuration to a network entity involved in performing model retuning of the first artificial intelligence or machine learning model to aid in the model retuning; monitoring and evaluating performance, by the network element, of a second artificial intelligence or machine learning model that is a retuned version of the first artificial intelligence or machine learning model, wherein the first and second artificial intelligence or machine learning models are from a same lineage of artificial intelligence or machine learning models; and storing, by the network element in response to the evaluation of the second artificial intelligence or machine learning model, the second artificial intelligence or machine learning model for use by other user equipment.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: evaluating, by a network element in a wireless network, performance of a first artificial intelligence or machine learning model being used by a user equipment in the wireless network; sending, by the network element based on the evaluation, configuration to a network entity involved in performing model retuning of the first artificial intelligence or machine learning model to aid in the model retuning; monitoring and evaluating performance, by the network element, of a second artificial intelligence or machine learning model that is a retuned version of the first artificial intelligence or machine learning model, wherein the first and second artificial intelligence or machine learning models are from a same lineage of artificial intelligence or machine learning models; and storing, by the network element in response to the evaluation of the second artificial intelligence or machine learning model, the second artificial intelligence or machine learning model for use by other user equipment.

An exemplary computer program product includes a computer-readable storage medium bearing instructions that, when executed by an apparatus, cause the apparatus to perform at least the following: evaluating, by a network element in a wireless network, performance of a first artificial intelligence or machine learning model being used by a user equipment in the wireless network; sending, by the network element based on the evaluation, configuration to a network entity involved in performing model retuning of the first artificial intelligence or machine learning model to aid in the model retuning; monitoring and evaluating performance, by the network element, of a second artificial intelligence or machine learning model that is a retuned version of the first artificial intelligence or machine learning model, wherein the first and second artificial intelligence or machine learning models are from a same lineage of artificial intelligence or machine learning models; and storing, by the network element in response to the evaluation of the second artificial intelligence or machine learning model, the second artificial intelligence or machine learning model for use by other user equipment.

In another exemplary embodiment, an apparatus comprises means for performing: evaluating, by a network element in a wireless network, performance of a first artificial intelligence or machine learning model being used by a user equipment in the wireless network; sending, by the network element based on the evaluation, configuration to a network entity involved in performing model retuning of the first artificial intelligence or machine learning model to aid in the model retuning; monitoring and evaluating performance, by the network element, of a second artificial intelligence or machine learning model that is a retuned version of the first artificial intelligence or machine learning model, wherein the first and second artificial intelligence or machine learning models are from a same lineage of artificial intelligence or machine learning models; and storing, by the network element in response to the evaluation of the second artificial intelligence or machine learning model, the second artificial intelligence or machine learning model for use by other user equipment.

In an exemplary embodiment, a method is disclosed that includes receiving, by a user equipment in a wireless network from a network element in the wireless network, configuration indicating the user equipment is to aid in performing retuning of a first artificial intelligence or machine learning model being used by the user equipment; performing, by the user equipment, one or more operations to aid in the performing retuning of the first artificial intelligence or machine learning model, wherein the retuning creates a second artificial intelligence or machine learning model that is a retuned version of the first artificial intelligence or machine learning model, wherein the first and second artificial intelligence or machine learning models are from a same lineage of artificial intelligence or machine learning models; and switching by the user equipment from the first artificial intelligence or machine learning model to the second artificial intelligence or machine learning model.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a user equipment in a wireless network from a network element in the wireless network, configuration indicating the user equipment is to aid in performing retuning of a first artificial intelligence or machine learning model being used by the user equipment; performing, by the user equipment, one or more operations to aid in the performing retuning of the first artificial intelligence or machine learning model, wherein the retuning creates a second artificial intelligence or machine learning model that is a retuned version of the first artificial intelligence or machine learning model, wherein the first and second artificial intelligence or machine learning models are from a same lineage of artificial intelligence or machine learning models; and switching by the user equipment from the first artificial intelligence or machine learning model to the second artificial intelligence or machine learning model.

An exemplary computer program product includes a computer-readable storage medium bearing instructions that, when executed by an apparatus, cause the apparatus to perform at least the following: receiving, by a user equipment in a wireless network from a network element in the wireless network, configuration indicating the user equipment is to aid in performing retuning of a first artificial intelligence or machine learning model being used by the user equipment; performing, by the user equipment, one or more operations to aid in the performing retuning of the first artificial intelligence or machine learning model, wherein the retuning creates a second artificial intelligence or machine learning model that is a retuned version of the first artificial intelligence or machine learning model, wherein the first and second artificial intelligence or machine learning models are from a same lineage of artificial intelligence or machine learning models; and switching by the user equipment from the first artificial intelligence or machine learning model to the second artificial intelligence or machine learning model.

In another exemplary embodiment, an apparatus comprises means for performing: receiving, by a user equipment in a wireless network from a network element in the wireless network, configuration indicating the user equipment is to aid in performing retuning of a first artificial intelligence or machine learning model being used by the user equipment; performing, by the user equipment, one or more operations to aid in the performing retuning of the first artificial intelligence or machine learning model, wherein the retuning creates a second artificial intelligence or machine learning model that is a retuned version of the first artificial intelligence or machine learning model, wherein the first and second artificial intelligence or machine learning models are from a same lineage of artificial intelligence or machine learning models; and switching by the user equipment from the first artificial intelligence or machine learning model to the second artificial intelligence or machine learning model.

### BRIEF DESCRIPTION OF THE DRAWINGS

In the attached drawings:

FIG. 1 is an example of a functional architecture of AI for an air interface;

FIG. 2 is an example of a signaling flow demonstrating a model monitoring/retuning/transfer framework;

FIG. 2A is an example of a lineage for a set of AI/ML models;

FIG. 3 is an example of a signaling flow for a single UE AI/ML model monitoring and retuning trigger;

FIG. 4 is an example of a signaling flow for multi-UE AI/ML model monitoring and retuning trigger;

FIG. 5 is an example of a signaling flow for UE-side retuning;

FIG. 6 is an example of a signaling flow for network-side retuning;

FIG. 7 is an example of a signaling flow for OTT-side retuning;

FIG. 8 is an example of a signaling flow for a UE-side retuned AI/ML model that is transferred/delivered to the network;

FIG. 9 is an example of a signaling flow for a UE-side retuned AI/ML model that is transferred/delivered to OTT;

FIG. 10 is an example of a signaling flow for a network-side retuned AI/ML model performance evaluation (where the network already has the retuned model);

FIG. 11 is an example of a signaling flow for an OTT-side retuned AI/ML model transfer/delivery to network;

FIG. 12 is an example of a signaling flow for retuned AI/ML model distribution; and

FIG. 13 is a block diagram of one possible and non-limiting exemplary system in which the exemplary embodiments may be practiced.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

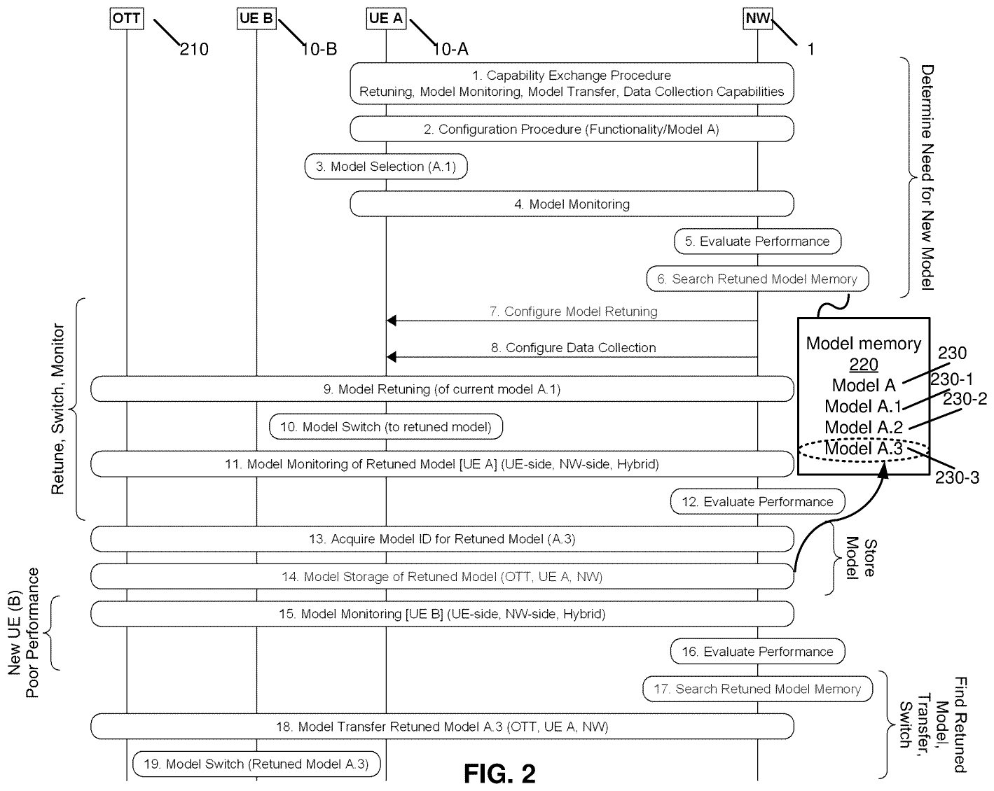

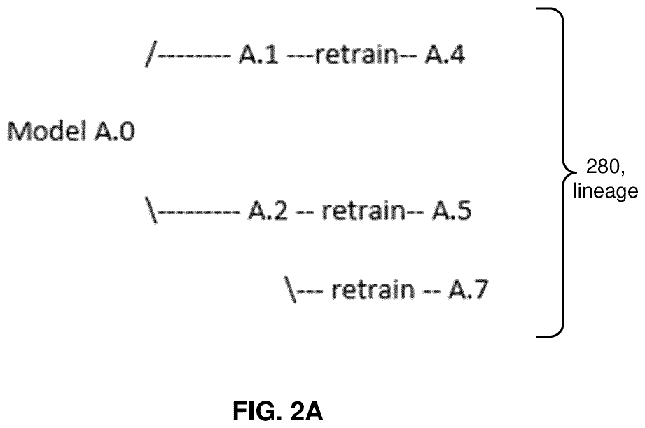

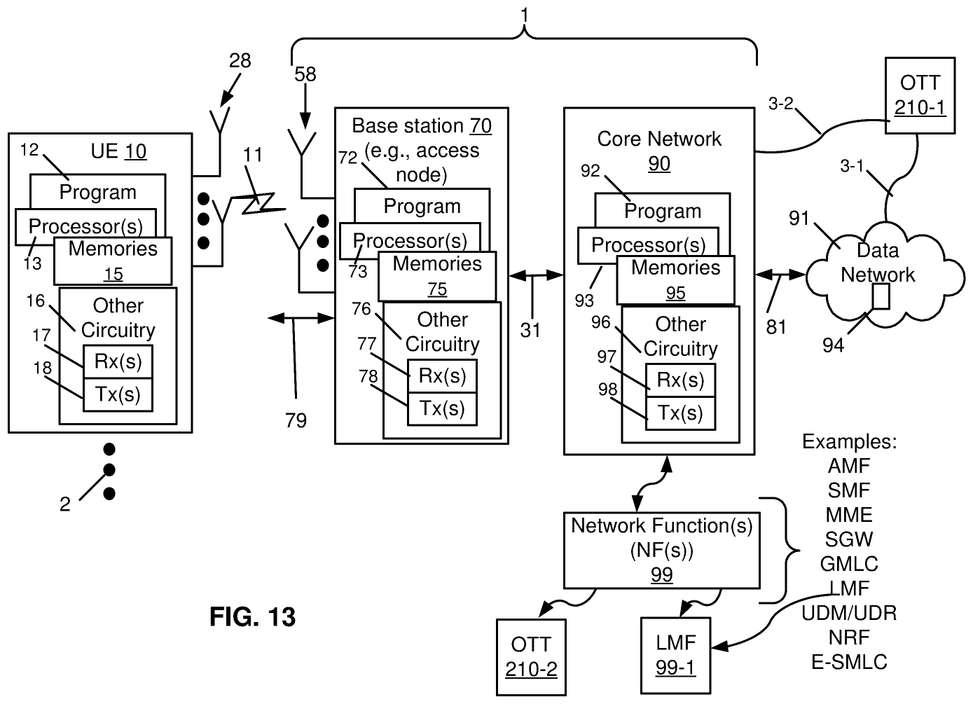

Any flow diagram or signaling diagram (see FIGS. 2-12) herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIG. 13) also illustrate the operation of an exemplary method, results of execution of computer program instructions embodied on a computer readable memory, functions performed by logic implemented in hardware, and/or interconnected means for performing functions in accordance with an exemplary embodiment.

The deployment of methods based on Artificial Intelligence (AI)/Machine Learning (ML) (collectively, AI/ML) for a New Radio (NR) air interface is currently being considered in 3GPP Rel-18 [see RP-213599, Qualcomm (Moderator), “New SI: Study on Artificial Intelligence (AI)/Machine Learning (ML) for NR Air Interface”, 3GPP TSG RAN Meeting #94e, Electronic Meeting, Dec. 6-17, 2021]. The ambition is to harness the advantages coming from embracing such solutions and to analyze the specification impact of extending the air interface with additional features which can support the deployment of AI/ML-based algorithms. To facilitate the development of a common AI/ML framework for the air interface, several use-cases are being considered in 3GPP Rel-18. Together with these use-cases, the functional requirements for the AI/ML architecture are currently being studied.

As a result of AI/ML models being created from large, aggregate datasets, AI/ML models may experience performance fluctuations when deployed in different geographic locations, channel conditions, scenarios, or for all time, e.g., the model's performance could decrease over time. To resolve degradation in UE performance, there are three options: fallback to a legacy non-AI/ML mechanism; obtain or switch to a new model; or retune an existing model to perform well under conditions more specific than could be addressed by the more general base model. Additionally, the degradation should be resolved quickly and efficiently, and ideally before the AI/ML model's performance drops below that of legacy techniques.

Throughout this document, the terms model update, model retuning, and model finetuning are used interchangeably.

RAN #110bis-e agreements on AI/ML positioning are as follows (between opening and closing quotation marks).

```
“Agreement
  Study and provide inputs on benefit(s) and potential specification impact
at least for the following cases of AI/ML based positioning accuracy enhancement
  Case 1: UE-based positioning with UE-side model, direct AI/ML or
AI/ML assisted positioning
  Case 2a: UE-assisted/LMF-based positioning with UE-side model, AI/ML
assisted positioning”
```

RAN1 #113 Agreements from AI: 9.2.4 on General aspects are as follows (between opening and closing quotation marks), see Draft Report of 3GPP TSG RAN WG1 #113 v0.1.0 (Incheon, South Korea, 22-26 May 2023).

```
“Agreement
  For the purpose of activation/selection/switching of UE-side models/UE-part of
two-sided models /functionalities (if applicable), study necessity, feasibility and potential
specification impact for methods to assess/monitor the applicability and expected performance of
an inactive model/functionality, including the following examples:
    Assessment/Monitoring based on input/output data distribution
    Assessment/Monitoring based on past knowledge of the performance of
the same model/functionality (e.g., based on other UEs)
  FFS: Requirements for the assessment/monitoring to be reliable (e.g., sufficient
data coverage during evaluation)
  FFS: Additional aspects specific to the case where the inactive model has never
been activated before, if any.”
```

RAN1 #113 agreements on data collection on general aspects of AI/ML framework are as follows (between opening and closing quotation marks).

```
  ″Agreement
  Consider at least the following aspects and if applicable,
  the corresponding
potential specification impact related to data collection:
    Measurement configuration and reporting
```

In RAN2 #122 the following was agreed (between opening and closing quotation marks), see Report of 3GPP TSG RAN WG2 meeting #122, Incheon, Korea:

```
  “Intention is to cover functional arch in general, e.g., covering both model
based and/or functionality based LCM
  ‘Model Storage’ in the figure is only intended as a reference point (if any)
for protocol terminations etc for model transfer/delivery etc. It is not intended to limit where
models are actually stored. Add a note for this.
  Remove 'Model' in Model Management and Model Inference and for the
actions/the arrow form Management to Inference (to reduce the risk for misunderstanding).
  Management may be model based management, or functionality based
management. Add a mote for this.
  With the modifications above Figure 2 from R2-2305327 is agreed”
```

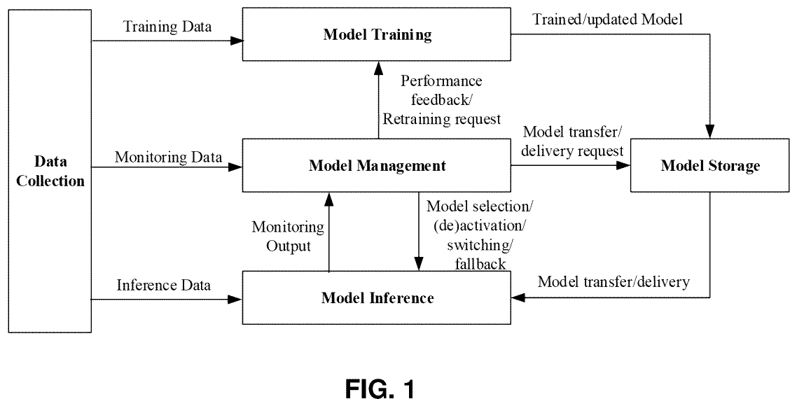

FIG. 1 is an example of a functional architecture of AI for air interface, and is FIG. 2 from R2-2305327 (vivo, “Discussion on architecture general”, 3GPP TSG-RAN WG2 Meeting #122, Incheon, Korea, 22-26 May 2023). There is a data collection block that produces training data, monitoring data, and inference data. The training data goes to the model training block, the monitoring data goes to the model management block, and the inference data goes to the model inference block. The model training block receives performance feedback/retraining request from the model management block, and produces a trained/updated model, which goes to a model storage block. The model management block additionally receives monitoring output from the model inference block, and sends model selection/(de) activation/switching/fallback to the model interference block. The model management block also sends model transfer/delivery request to the model storage. The model inference block receives model transfer/delivery from the model storage block.

For the model transfer/delivery agenda item, the following was agreed in RAN2 #121.

```
Agreed:
  Aim to at least analyze the feasibility and benefits of
  model/transfer solutions
  based on the following:
  Solution la: gNB can transfer/deliver AI/ML model(s)
  to UE via RRC
  signaling.
  Solution 2a: CN (except LMF) can transfer/deliver
  AI/ML model(s) to UB via
  NAS signaling.
  Solution 3a: LMF can transfer/deliver AI/ML model(s)
  to UE via LPP
  signaling.
  Solution 1b; gNB can transfer/deliver AI/ML model(s)
  to UE via UP data.
  Solution 2b: CN (except LMF) can transfer/deliver
  AI/ML model(s) to UE via
  UP data.
  Solution 3b: LMF can transfer/deliver AI/ML model(s)
  to UE via UP data.
  Solution 4: Server (e.g., OAM, OTT) can transfer/
  delivery AI/ML model(s) to
  UE (e.g., transparent to 3GPP).
```

Example of problems that can be solved include the following.
1) Defining procedures (e.g., monitoring) and conditions (e.g., one or more UEs reporting KPIs below configured thresholds) under which to trigger a UE to retune its model.
2) Identifying the entities involved in the model update/retuning and specify the relevant procedures involving, retuning conditions, switching, data collection, and model transfer.
3) Limiting the number of models that are concurrently deployed and in operation under the same conditions (e.g., channel conditions, geographical area, line of sight, or non-line of sight).
4) How to track the models and trigger appropriate model monitoring procedures.
5) How to intelligently select one, or a subset of UEs, to perform the data collection for the retuning task.
6) How to distribute the new, retuned AI/ML model to affected UEs currently using the degraded AI/ML model.
7) How to make available for distribution the new, retuned, AI/ML model for UEs when it is detected that the UE would perform better with the retuned AI/ML model.

The problem initially applies to three use cases defined by 3GPP: CSI feedback enhancement; Beam Management enhancement; and Positioning enhancement. These use cases, in aggregate, apply to the UE, gNodeB, LMF, and third-party, or over-the-top (OTT) vendor server; thus, the techniques used should cover each of these cases.

Examples focus on the model monitoring aspects as part of the life cycle management (LCM) as agreements presented in the RAN2 #122 (e.g., functional architecture of AI for air interface as in FIG. 1). In short, LCM includes multiple phases including data collection, model training, model management, model inference and model storage related issues. The functional architecture of AI for air interface depicts interaction between different phases but does not specify what entities and interaction procedures are involved.

Note that throughout this document, terms such as monitoring, training, and retuning are used, but the intention is not to define or augment those mechanisms, but to use them as triggers and/or outputs to be used in the process of distributing known working models and to trigger retuning with the intent of distributing the resulting retuned AI/ML model. Definitions of possible geographical details, scenarios, channel conditions, and the like, are only provided as examples, but otherwise left for future study.

Furthermore, the table below shows the agreed terminologies from R1-2205695 and based on the agreements from RAN1 #11, and these terminologies are applied herein:

| Terminology | Description |
|---|---|
| Data collection | A process of collecting data by the network nodes, |
| | management entity, or UE for the purpose of AI/ML model |
| | training, data analytics and inference |
| AI/ML Model | A data driven algorithm that applies AI/ML techniques to |
| | generate a set of outputs based on a set of inputs. |
| AI/ML model training | A process to train an AI/ML Model [by learning the |
| | input/output relationship] in a data driven manner and obtain |
| | the trained AI/ML Model for inference |
| AI/ML model | A process of using a trained AI/ML model to produce a set of |
| Inference | outputs based on a set of inputs |
| AI/ML model | A subprocess of training, to evaluate the quality of an AI/ML |
| validation | model using a dataset different from one used for model |
| | training, that helps selecting model parameters that generalize |
| | beyond the dataset used for model training. |
| AI/ML model testing | A subprocess of training, to evaluate the performance of a |
| | final AI/ML model using a dataset different from one used for |
| | model training and validation. Differently from AI/ML model |
| | validation, testing does not assume subsequent tuning of the |
| | model. |
| UE-side (AI/ML) | An AI/ML Model whose inference is performed entirely at the |
| model | UE |
| Network-side | An AI/ML Model whose inference is performed entirely at the |
| (AI/ML) model | network |
| One-sided (AI/ML) | A UE-side (AI/ML) model or a Network-side (AI/ML) model |
| model | |
| Model monitoring | A procedure that monitors the inference performance of the |
| | AI/ML model |
| Supervised learning | A process of training a model from input and its |
| | corresponding labels. |
| Model activation | enable an AI/ML model for a specific AI/ML-enabled feature |
| Model deactivation | disable an AI/ML model for a specific AI/ML-enabled feature |
| Model switching | Deactivating a currently active AI/ML model and activating a |
| | different AI/ML model for a AI/ML-enabled feature |

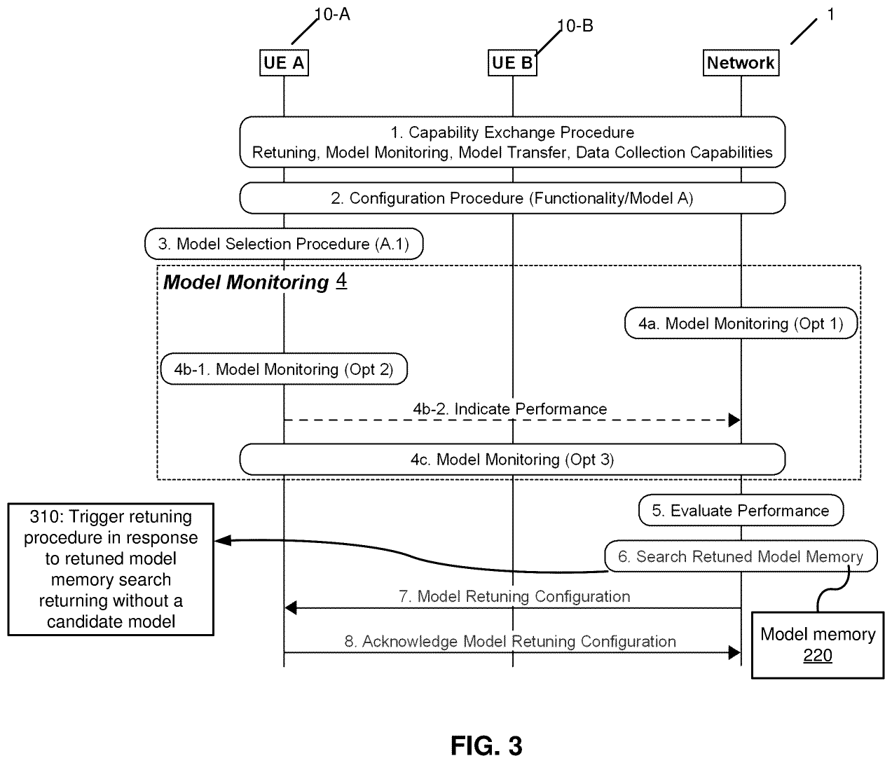

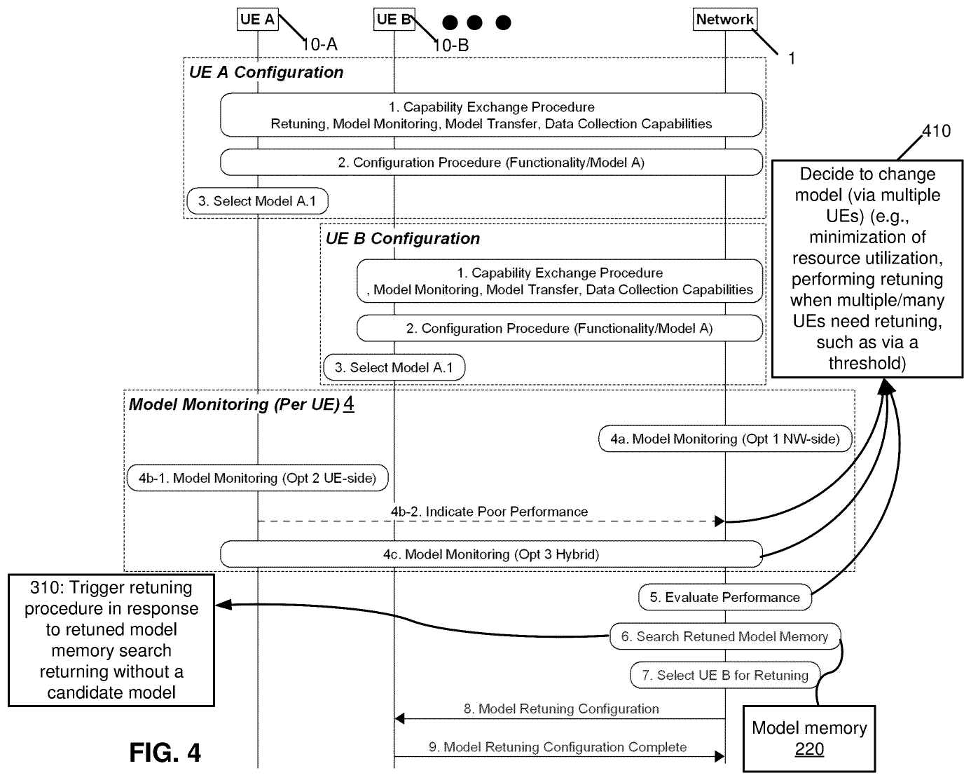

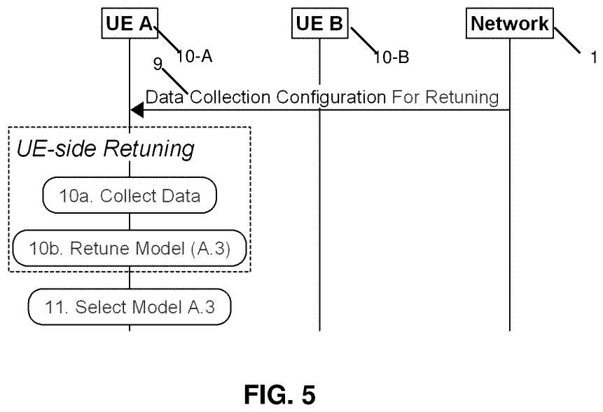

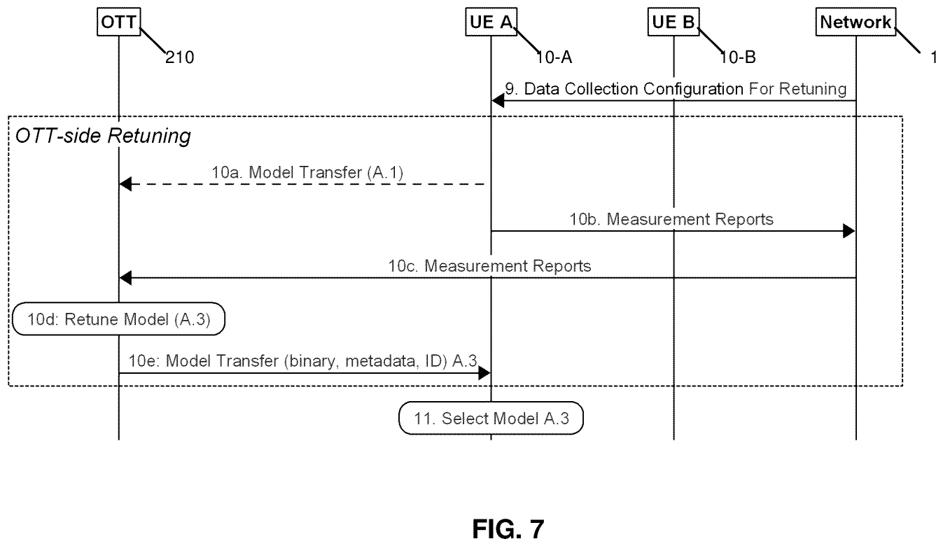

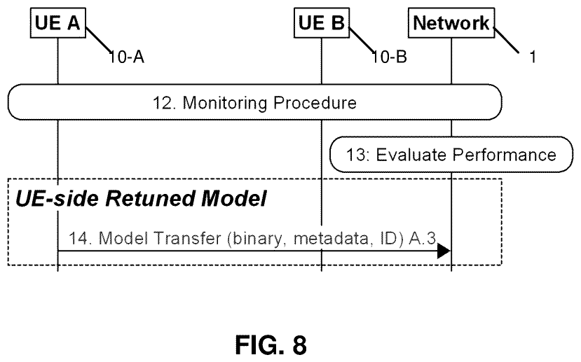

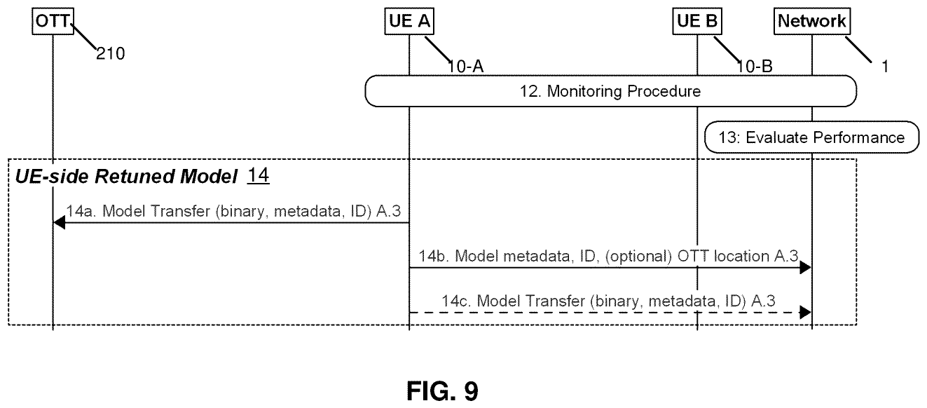

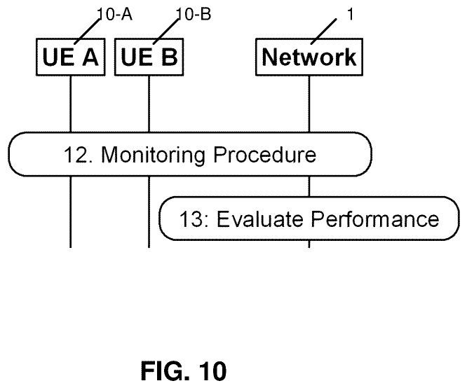

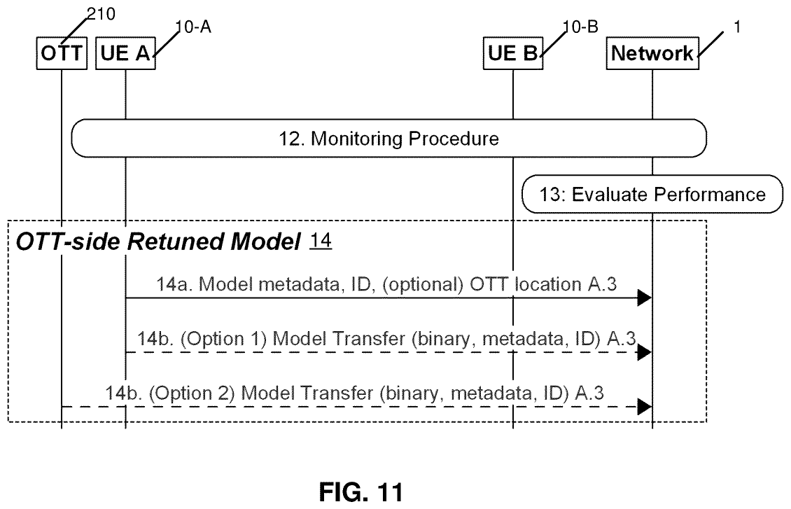

The exemplary embodiments herein address one problem, some problems, or all of the problems described above. Multiple signaling flow diagrams are used to illustrate aspects of the examples. The flow diagrams are generally described as follows: FIG. 2 provides an overview; FIGS. 3 and 4 provide explanation of single-UE (FIG. 3) and multiple-UE (FIG. 4) model monitoring and retuning trigger; FIGS. 5-7 describe options for retuning for the UE, network, or OTT server, respectively; FIGS. 8 and 9 describe how a UE-side retuned model could be transferred/delivered to the network (FIG. 8) or the OTT server (FIG. 9), and these figures may depend from where FIG. 5 ends; FIG. 10 describes a network-side retuned model evaluation, may depend from where FIG. 7 ends; FIG. 11 describes OTT-side retuned model delivery to the network; and FIG. 17 describes retuned model distribution when the network or OTT server has the model.

Turning to FIG. 2, this figure is an example of a signaling flow demonstrating a model monitoring/retuning/transfer framework. The entities in the figure are the following: an OTT server 210; UEs A 10-A and B 10-B; and the NW 1. The OTT server 210 could be deployed inside an operator's network (e.g., in a core network) or externally, accessible over the internet or through a secure connection to the operator's network.

FIG. 2 shows a call flow summarizing different steps of one proposed example. This illustrates possible LCM procedures, e.g., re-tuning/update, model storage, data collection, switching, and model transfer/delivery that can be triggered as a result of the model monitoring procedures, which could be either UE-based or network-based. The following are the steps that are involved, and these are described further below too.

In step 1, a capability exchange procedure is performed between the UE A 10-A and the NW 1. The procedure involves signaling capabilities of one or more of the following: retuning; model monitoring; model transfer; or data collection. In step 2, there is a configuration procedure that instructs a UE to configure itself for a functionality or for a specific AI/ML model. This is intended to cover functionality-based and model-based configuration. In functionality-based, it would be up to the UE to select a model that enables the functionality; and in model-based, the NW would directly select a model.

There is a model selection of Model A.1 in step 3. In one example, Model A. 1 is a first version of the model—not retuned, but rather only initially trained. In another example, Model A.1 is a first retuned version of Model A, which is a base model from which retuned models are derived. There is a model monitoring procedure performed in step 4. The NW 1 evaluates performance in step 5, and searches retuned model memory in step 6. The searching uses model memory 220, which has Model A 230, Model A.1 230-1, and Model A.2 230-2 (Model A.3 230-3 is added below). A result of this is that no appropriate AI/ML model is found (e.g., based on criteria). The steps 1-6 may be considered to be a process for determining need for a new model. It is noted that the model memory 220 may not have any retuned versions of models.

This example involves step 7, which configures model retuning by the NW 1 on the UE A 10-A, and also step 8, which configures data collection by the NW 1 on the UE A 10-A. Step 8 allows the UE to collect data for retuning the model. Steps 7 and 8 provide configuration to the UE to aid in the model retuning that is performed later. The UE A 10-A in step 9 performs model retuning (e.g., of the current model A.1, and this is an operation to aid retuning) and in step 10 performs a model switch (e.g., to the retuned model). In step 11, there is a model monitoring performed on the retuned model (e.g., being used by UE A), and may be performed on the UE-side, the NW-side, or a hybrid (e.g., part UE and part NW). Step 11 may be performed by all the elements 210, 10-B, 10-A, and 1. In step 12, the NW 1 evaluates performance. The evaluation of performance in step 12 is to evaluate whether the retuned model A.3 should become a model that is stored and used by other UEs. In this case, the retuned model A.3 is, based on criteria, accepted as a model that is to be stored and used by other UEs. The steps 7-12 are a retune, switch, and monitor procedure.

In step 13, the elements acquire model ID for a retuned model (e.g., A.3). In step 14, the elements perform model storage of a retuned model. This may be performed by the OTT server 210, the UE A 10-A, or the NW 1. Steps 13 and 14 may be considered to be a model storage procedure. In this example, Model A.3 is stored in model memory 220 as Model A.3 230-3.

In step 15, there is additional model monitoring, e.g., by the UE B 10-B, which also would be UE-side, NW-side, or a hybrid (part UE, part NW). The NW 1 in step 16 evaluates performance of the model. Steps 15 and 16 represent a new UE (B) running a model (A.1) experiencing poor performance. With respect to step 15, one may consider the procedures related to UE A to be complete, so while monitoring would continue even for UE A, that is not relevant to the rest of the signaling diagram. For UE B, Model A.I would be monitored since that model what UE B has.

In step 17, the NW 1 again searches a retuned model memory 220. In step 18, the entities perform a model transfer of the retuned model A.3, Model A.3 230-3 (e.g., performed by the OTT server 210, the UE A 10-A, or the NW 1). In step 19, a model switch is performed, e.g., to use the retuned model A.3 by the UE B 10-B. Steps 17-19 can be considered to find a retuned model, transfer, and switch. In the example of FIG. 1, step 18 refers to a model transfer, assuming that Model A.3 230-3 would be transferred to the to the UE B 10-1. However, UE B might actually have A.3 and the NW 1 can have the UE B to just switch to Model A.3 in step 18 instead of using a “transfer”.

Examples herein aim to solve one or more of the problems in the previous section through the definition of a procedural flow involving the following steps. Note that these are a summarization, so the numbered items do not match with FIG. 2.
1. The UE provides its AI/ML capabilities to the network. See step 1. For example the UE provides its AI/ML capabilities, which include, but are not limited to data collection capabilities; on-device retuning capabilities; model monitoring capabilities; and model transfer/delivery capabilities.
2. A first performance monitoring phase (see steps 4-5) indicates degraded or poor performance of an AI/ML model in one or more UEs that are operating under similar conditions. The detailed examples of conditions are discussed below.
3. An optional step may be performed to collect monitoring data from target UE(s) running the same AI/ML model, which could be shared with the one or more UEs, shared by the network or external server (e.g., OTT). See, e.g., steps 4-5. It should be noted that steps 4 and 5 could be performed for multiple UEs, e.g., UE A, UE B, . . . , and other UEs.
3a. The evaluation of performance (e.g., in step 5) can use many evaluation tools and/or algorithms, such as determining values for one or more KPIs.
3b. After the performance is evaluated, a search can be performed of a retuned model memory 200, which has multiple retuned models. In this example, the model memory 220 contains Model A 230, Model A.1 230-1, and Model A.2 230-2 (Model A.3 230-3 is added later). These models are identified by globally unique model IDs (also referred to as unique global model IDs or unique global IDs), such that the NW 1 can retrieve the exact model that is requested. In another example, the models are defined via lineage and their corresponding unique global IDs. For instance, Model A->Model A.1->Model A.3 are examples of the lineage and each of these has a corresponding unique global ID. Note also that there could be a lineage of Model A->Model A.1->Model A.2 also, or even Model A->Model A.1-> (Model A.2 and Model A.3), where the parenthetical indicates both A.2 and A.3 are retuned versions of A.1. As yet another example, Model A-> (Model A.1 and Model A.2) and Model A.1->Model A.3 is another lineage. Regardless of how the lineage is formed, there is a known lineage, and any model can be accessed by using the corresponding unique global ID of a specific model.

FIG. 2A shows another example of a same lineage for a set of AI/ML models 230. This example has a Model A.0 that has two initially trained Models A.1 and A.2 in the lineage 280. The Model A.1 is retrained to create Model A.4, which is a retuned version of Model A.1. Herein, retuning includes retraining and other options, described below. The Model A.2 is retrained multiple times to create Models A.5 and A.7.

It is noted that the term “lineage” herein is used. Other terms may also be used to describe the relationships described in FIG. 2A and herein, such as the following: hierarchy; model tree (from graph theory) such as a rooted tree of models; model inheritance; model relationship; or any other terminology indicating a data structure where individual nodes are models and the models have relationships and globally unique IDs. It is noted that the method by which model IDs are assigned or related to one another is not within the scope of this document.

Any model derived from the first Model A.0 could be a candidate for retrieval from model memory 220, e.g., the UE comes with Model A.4, but the model memory 220 can retrieve Model A.7, e.g., if this model fits the conditions for the functionality. It could also be that the UE comes with the “original model”, Model A.0, and is later provided one of the retuned versions, like Model A.5. It is further noted that there could be multiple “original models”, e.g., each supporting different functionality, and different lineages 280 for these models.

For the concept of retuning a model, the model retuning could perform the following or a combination of the following: 1) add or remove layers; create a new layer and swap it in to replace a layer; 3) target specific (unfrozen) layers for the retuning, e.g., generate new parameters (e.g., weights) for a subset of layers; and/or 4) target all layers for the retuning, e.g., generate new parameters (e.g., weights) for at least one, up to all of the layers.

Example criteria for the search performed in step 6 of FIG. 2 may be simple: find a version of Model A that has been retuned and performed well (e.g., based on certain performance criterion/criteria and corresponding threshold(s)) in the location of the NW element, e.g., the gNodeB (based on performance on that exact cell—or cells nearby if the models are shared among gNodeBs) or LMF (based on a geographical area).

For FIG. 2 and step 4. Based on, e.g., a comparison of the monitoring KPI to a threshold value, the network triggers the one or more UEs to retune their model, which could be performed locally on the UEs or at an external server. See, e.g., step 9. The comparison of the monitoring KPI to a threshold value may occur anytime an evaluation of performance for a model is performed. See steps 6, 12, and 16, and other steps in other figures. Wherever KPIs are used for evaluation of performance herein, these are not the only metrics that can be used. Consider the following examples. Examples that the NW can use to evaluate performance that would not be (directly) related to the KPIs could be:
a) Cell-level parameters (e.g., cell load);
b) Side information on the UE, e.g., velocity (if the UE moves fast, then there is no reason for the NW to trigger re-training as it is likely that the model would become outdated); and/or
c) Position of the UE and/or likelihood that the UE would move to another cell (e.g., if the UE is at cell edge, then triggering re-training of the model might not make sense, since the UE may be handed over to another cell which has different configuration).
5. A second performance monitoring phase indicates that the retuned AI/ML model's performance exceeds the performance (as one possible criterion) of the degraded AI/ML model. See steps 11-12. That is, the retuned model is evaluated (see step 12) through a monitoring procedure, and if the retuned model performs well, the model is stored and distributed to other UEs and used as a result in future searches of the model memory.
6. The UE transfers/delivers its retuned AI/ML model, ID, and optional metadata to the network and/or an external server. See steps 13-14. Step 14 may add the retuned Model A.3 to the model memory 220. By splitting the metadata from the model itself, this allows the network to simply store the metadata and a pointer to where to find the model, or simply the model ID itself if the UE is expected to do its own search for the model.
7. The UE signals to the network at least the model ID and the model location, in case the model was only transferred/delivered to an external server (as the OTT server), and optionally the model metadata (description of which is not in scope of this description).
8. The network either directly transfers/delivers the retuned AI/ML model to other affected UEs or commands the other affected UEs to download the model from the retuned model storage location.
9. When subsequent UEs with the same initial model (e.g., pre-retuned model) are configured with a functionality served by the retuned model, and the conditions match those of the retuned model, the network assists the UEs in acquiring and/or selecting the newly retuned model instead of performing another retuning procedure. And model monitoring indicates subpar performance. That is, there is no need to switch to a new model if the original model (e.g., Model A.1) happens to work well.

Features of examples herein may include the use of AI/ML performance monitoring of one or more UEs to trigger the retuning of the model, the aggregation of data collection from nearby UEs running the same AI/ML model, whose performance falls below a standardized or network-configured KPI value, for use in the retuning procedure, the assignment of a new model ID to the retuned model, and the transfer/delivery of the newly retuned AI/ML model to UEs part of the original set of degraded UEs, and to future UEs that enter the same conditions that would perform well with the retuned AI/ML model. The examples may be agnostic to the UE vendor, UE device model, and internal details of the model, and support transparent use of AI/ML model binaries.

One feature described above, and in more detail below, is the recall of a retuned model. Other steps regard using a minimal number of UEs, as few as one UE, to perform the retuning and transferring that model to the network so that other UEs do not have to perform the same retuning, which would result in many slightly different versions of a retuned model. This saves both time, as only one or a few UEs perform retuning, and memory, as only one retuned model instead of many are stored. Aggregating monitoring data from UEs running the same model is one possible optimization to strengthen the need to retune and share the retuned model.

The models themselves, as well as their retuned versions, have globally unique IDs. In this manner, the models can be retrieved and stored so that the exact model can be used, evaluated, and retuned.

In the additional call flows that follow, note that the assignment of the model ID (e.g., Model A, Model A.1, and Model A.3) has not been specified as it has in FIG. 2 because there are many places that this could occur. The management of the model ID assignment is out of the scope of this document, but the assignment of a new model ID to the retuned model is considered to be one aspect of the examples.

For the call flow described by FIG. 2 and all figures that follow, protocol steps between the UE and network entities could be implemented by, but are not limited to, the radio resource control (RRC) protocol between the UE and the gNodeB; the LTE positioning protocol (LPP) between the UE and the LMF; or the non-access stratum (NAS) protocol between the UE and the core network, namely the access and mobility function (AMF).

While FIG. 2 provided a broad overview, additional examples herein will be described in parts to aid in providing embodiments that can be combined from various options throughout each stage of the procedure. These parts include the capability exchange procedure through retuning configuration, coordinated data collection as input to the retuning procedure, monitoring the performance of the retuned model, and the transfer/delivery of the retuned model.

Initial performance monitoring is now described. In the first part of the procedure, the network configures one (FIG. 3) or more (FIG. 4) UEs with a functionality (functionality A in the example) or a model directly (A.1 in the example), for which the UE(s) select a compatible model (model A.1 in our example). Either the network, the UE, or both in a hybrid approach, configures a monitoring procedure, which determines that the AI/ML model's performance falls below a standardized or network-configured KPI value, e.g., for CSI: intermediate KPIs such as square generalized cosine similarity (SGCS) and eventual KPIs such as throughput, hypothetical block error rate (BLER), BLER, or ACK/NACK (ability to decode transmission); for beam management: top-K beams fall below 95% CI or throughput falls below a specified value; and for positioning: positioning accuracy falls below a specified value. Prior art allows the network or UE to optionally search for a new model, but when a well-performing model, as measured by the aforementioned KPIs, is not found, the network triggers AI/ML model retuning in the single UE part of the monitoring procedure (FIG. 3), or one of several UEs that the network has selected (FIG. 4). The decision to trigger the AI/ML model retuning, could, thus, be based on the monitoring results of a single UE or of many UEs.

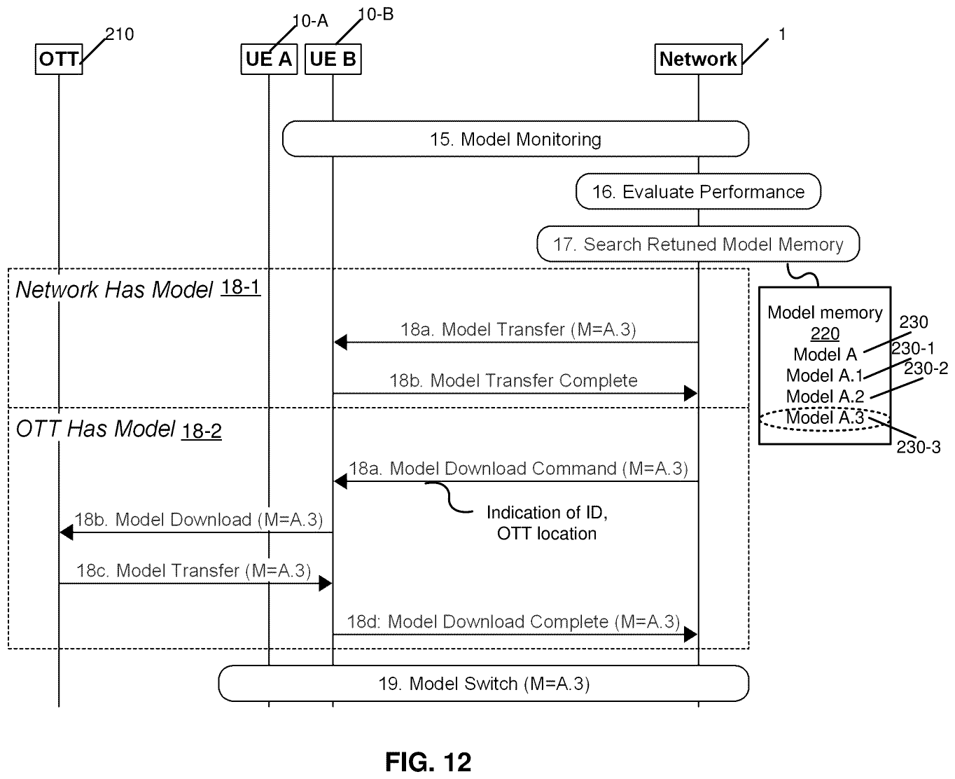

In FIG. 3, the following steps are performed.
1. Capability exchange procedure—This procedure, depending on the use case, could be between the UE 10 and gNodeB (as the NW 1), between the UE and the core network, and/or between the UE and the location management function (LMF), which is an element in the core network. The purpose is for the UE to signal its capabilities, and in the case of this example, its AI/ML capabilities, for example, but not limited to data collection capabilities; on-device retuning capabilities; model monitoring capabilities; and model transfer/delivery capabilities.
a. In an embodiment as part of UE-capability transfer, the UE can provide the list of supported functionalities corresponding to different model identifications.
2. Configuration procedure—Once the network is aware of the UE's capabilities, it configures the UE with a functionality, which maps to a use case, and/or sub-use case, e.g., CSI compression, CSI prediction, beam management, direct/assisted AI/ML positioning, and the like.
3. Model selection procedure—The UE selects a model that performs the configured functionality or selects the model that the UE was directly configured to select in step 2 if a specific model was configured. It is noted that the UE can have its own repository of models and can choose between these.
4. Model monitoring—Either the network, the UE, or a combination of both (hybrid) monitors the performance of the AI/ML model. In the case of network-based or hybrid monitoring, the monitoring result is available at the network, and in the case of UE-based monitoring, the monitoring result is signaled from the UE to the network. The model monitoring 4 may include the following: model monitoring in step 4a, which is option (Opt) 1; model monitoring in step 4b-1 (option 2), where the UE A 10-A may indicate performance in step 4b-2 to the network 1; and/or 4c (option 3), where model monitoring is performed as option 3 between the UE A 10-1, UE B 10-B, and the network 1.
5. Evaluate Performance—the network 1 determines an AI/ML model's performance falls below a standardized or network-configured KPI value.
6. Search Retuned Model Memory—the network 1 searches (from model memory 220) for a suitable model, e.g., a previously retuned model, but returns no results. If the network found a model (e.g., a previously retuned model) that the UE could use, then the process continues at step 18 of FIG. 12. In this example, however, no retuned model is found. As indicated by block 310, a retuning procedure (e.g., steps 7 and 8) is performed in response to the retuned model memory search returning without a candidate model.
7. Model retuning configuration—the network configures the UE to retune its model, e.g., model A.1.
8. Acknowledge model retuning configuration—the UE acknowledges the retuning configuration.

Steps 7 and 8 provide configuration to the UE to aid in the model retuning that is performed later.

The combination of steps 5-8 of this procedure creates a new procedure, which emphasizes the optimality of the retuning trigger. When the network determines the performance of an AI/ML model is poor, the network does not skip immediately to retuning, instead network first tries to reuse a known-working model, and might only trigger the retuning procedure as a last resort.

In FIG. 4, a similar set of steps to FIG. 3 are provided, except that two UEs are considered. Steps 1-6 are identical, except that steps 1-3 are repeated for UE B 10-B. The augmentation in this embodiment is that, in step 4, the performance of the same model running on multiple UEs is considered in aggregate, and in step 7, multiple UEs 10 are considered to perform the retuning procedure. The network could use any type of criteria to determine that a UE is well-suited for the role, e.g., its location, channel conditions, signal level, applicable area/zone/scenario, and the like. The network could, in some implementations, choose more than one UE to retune to mitigate the risk that a UE leaves the coverage area without completing the AI/ML retuning procedure and in the second monitoring phase, described in FIG. 8, FIG. 9, FIG. 10, and FIG. 11, choose the best of the retuned AI/ML models. Steps 8 and 9 provide configuration to the UE B to aid in the model retuning that is performed later.

Another augmentation, as indicated by block 410, is the indication (step 4b-2, though this might also involve one or both of steps 4c and 5) of poor performance for a particular model, if indicated by multiple UEs 10, may cause the network 1 to decide to change the model (e.g., minimization of resource utilization, performing retuning when multiple/many UEs need retuning, such as via a threshold). For instance, if 10 UEs are using the model, and three UEs report poor performance, this might cause the network 1 to determine to change the model (and perform steps 6 and 7 to effect the change). A threshold number or percentage of UEs that have implemented the model could be used for this step. Note that the multiple UE aspect is one example, as if there is a single UE (e.g., as in FIG. 3) with the model and that UE has indicated poor performance, the network 1 may decide to change that model.

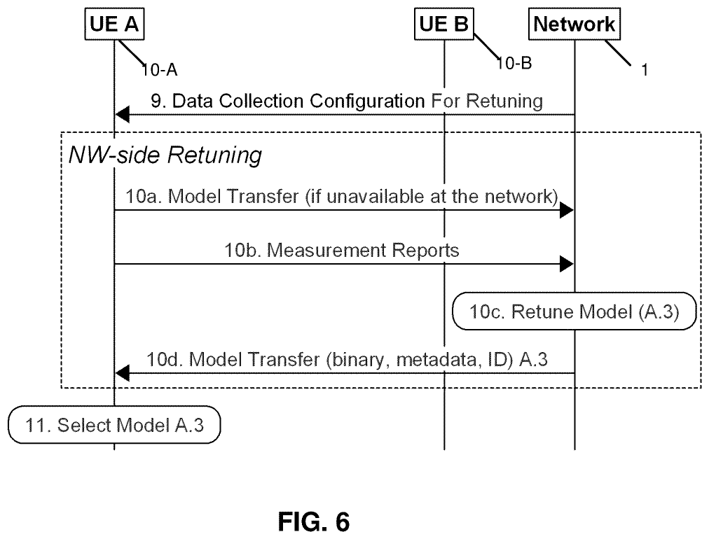

Next described is an AI/ML model retuning procedure. Continuing from step 8 of FIG. 3, the following three examples show UE-side retuning (FIG. 5), network-side retuning (FIG. 6), and OTT-side retuning (FIG. 7).

Each of the procedures has the same set of basic steps, with differences in where each step takes place, and the necessity for AI/ML model transfer/delivery as part of the retuning procedure. The main steps will be described as part of the description of FIG. 5, while the differences will be described on a per-figure basis.

It is noted that model storage is not covered in FIGS. 5-7, but is instead covered in FIG. 8, FIG. 9, and FIG. 10. In FIG. 8, the model is transferred to the network, and in FIG. 9, the model is transferred to an OTT server. In FIG. 10, the network already has the model. Additionally, model storage and model memory could be considered separate, since the model binary does not need to be collocated with the network's model memory, e.g., the network might know the model ID and metadata, but the model is actually stored in an OTT server.

The following steps take place as part of the UE-side retuning procedure in FIG. 5.
9. Data collection configuration (for retuning)—The UE is configured to collect measurements, including labels (i.e., ground truth), on signals transmitted by the network and/or sensor data available to the UE and is optionally provided assistance data for use in retuning. Examples of collected data include but are not limited to reference symbol measurements (e.g., CSI RS, PRS); sensor measurements (e.g., barometric pressure, velocity, acceleration); and non-RAT measurements (e.g., GNSS location). Step 9 provides configuration to the UE to aid in the model retuning that is performed later.

UE-side retuning includes the following.
10. (a) Collect data—the UE collects data until a sufficient dataset has been created for the retuning procedure. Sufficiency of the dataset could be dependent on a threshold number of samples, also considering diversity of the collected data, and/or based on a maximum collection time configured by the network.
10. (b) Retune model—the collected data is used to produce a retuned model (Model A.3 in this example) locally in the UE. Steps 10a and 10b are operations the UE takes to aid retuning of the model, in this case collecting data and actually retuning the model.
11. Select model—retuned AI/ML model, A.3, is selected to perform the configured functionality, Functionality A.

Steps 10 and 11 may be considered to be a combined step.

For the following example, it is assumed that an entity in the network is able to perform the AI/ML model retuning and is, therefore, capable of running the AI/ML model. The following steps take place as part of the network-side retuning procedure in FIG. 6.
9. Data collection configuration for retuning—The UE is configured to collect measurements, including labels, on signals transmitted by the network and/or sensor data available to the UE and is optionally provided assistance data for use in retuning. Examples of collected data include, but are not limited to, reference symbol measurements (e.g., CSI RS, PRS); sensor measurements (e.g., barometric pressure, velocity, acceleration); and non-RAT measurements (e.g., GNSS location). Step 9 provides configuration to the UE to aid in the model retuning that is performed later.

NW-side retuning includes the following.
10. (a) Model transfer/delivery—If the network does not have a copy of the AI/ML model to be retuned, the UE first/delivers the model to the network.

(i) In another embodiment, the network could directly download the AI/ML model to be retuned from an OTT server if the OTT server has stored the specific AI/ML model.
10. (b) Measurement reports—The UE transmits, to the network, measurement reports containing collected data, which could include measurements, and associated labels, as configured. The configuration could also include a threshold number of samples, possibly also considering diversity of the collected data, and/or based on a maximum collection time. Step 10b (or 10a if performed) are operations taken by the UE to aid in retuning the model.
10. (c) Retune model—this step is implementation specific, but the collected data is used to retune the model.
10. (d) Model transfer/delivery—the network transfers/delivers the retuned model, A.3, to the UE. The UE optionally transfers/delivers, to the OTT server 210, one of the following, which could be in a binary format: (1) its retuned model; (2) the delta between the original and retuned model; or (3) information required to reconstruct the retuned model, metadata; and a unique ID associated with its retuned model. The unique model ID (for Model A.3 in this example) is a globally unique ID to identify a model or the model represented by the original model and the delta or original model and information required to reconstruct the retuned model.
11. Select model—retuned AI/ML model, A.3, is selected by the UE to perform the configured functionality, Functionality A.

Steps 10 and 11 may be considered to be a combined step.

The following steps take place as part of the OTT-side retuning procedure in FIG. 7.
9. Data collection configuration for retuning—The UE is configured to collect measurements, including labels, on signals transmitted by the network and/or sensor data available to the UE and is optionally provided assistance data for use in retuning. Examples of collected data include, but are not limited to reference symbol measurements (e.g., CSI RS, PRS); sensor measurements (e.g., barometric pressure, velocity, acceleration); and non-RAT measurements (e.g., GNSS location). Step 9 provides configuration to the UE to aid in the model retuning that is performed later.

The process for OTT-side retuning and includes steps 10a, 10b, 10c, 10d, and 10e.
10. (a) Model transfer/delivery—the UE transfers/delivers the AI/ML model to be retuned (A.1) to the OTT server, if the OTT server does not already have the AI/ML model.
10. (b) Measurement reports—The UE transmits, to the network, measurement reports containing collected data, as configured. Steps 10a and 10b are operations the UE takes to aid in the retuning of the model.
10. (c) Measurement reports—The UE transmits, through the network 1 to the OTT server (or the network 1 transmits measurements collected from the UE to the OTT server), measurement reports containing collected data, which could include measurements, and associated ground truth, as configured. The configuration could also include a threshold number of samples, a threshold number of samples, also considering diversity of the collected data, and/or based on a maximum collection time. In another embodiment, the UE can transmit measurements directly to an OTT server, instead of going through the network.
10. (d) Retune model—this step is implementation specific, but the collected data is used to retune the model.
10 (e) Model transfer/delivery—The OTT server delivers the retuned AI/ML model, A.3, to the UE. The OTT server optionally transfers/delivers, to the UE A, one of the following, which could be in a binary format: (1) its retuned model; (2) the delta between the original and retuned model; or (3) information required to reconstruct the retuned model, metadata; and a unique ID associated with its retuned model. The unique model ID (for Model A.3 in this example) is a globally unique ID to identify a model or the model represented by the original model and the delta or original model and information required to reconstruct the retuned model.
11. Select model—retuned AI/ML model, A.3, is selected to perform the configured functionality, Functionality A

Steps 10 and 11 are considered as a combined step.

In another embodiment, the UE may, in step 10a, first transfer/deliver its model (A.1) to the network, which would deliver the model to the OTT server. Similarly, in step 10e, the new model (A.3) could be delivered from the OTT server to the network, and then to the UE.

Next, the final performance monitoring phase is described. The final monitoring phase determines whether the retuned AI/ML model performs well compared to the performance of the original model and/or the legacy method. As in the initial monitoring phase, the AI/ML model's performance is evaluated against a standardized or network-configured KPI value. If the performance meets that threshold, the retuned AI/ML model is transferred/delivered to a location where it can be reused, and the model ID and optional metadata, which could include, but is not limited to: a pairing ID for a two-part model; a device compatibility ID; a device hardware ID; applicability of the model (e.g., channel conditions, environmental conditions, or other network conditions for which the AI/ML model has been validated to perform well), are transferred/delivered to the network.

Continuing from step 11 of FIG. 5, a first option for model transfer/delivery is presented in FIG. 8, wherein the retuned AI/ML Model is transferred/delivered to the network.
12. Monitoring procedure—Once the retuned AI/ML model, A.3, has been selected, the monitoring procedure checks the performance of the retuned AI/ML model as in step 4 of FIGS. 3 and 4.
13. Evaluate performance—The AI/ML model's performance is evaluated against a standardized or network-configured KPI value to determine that the performance of the retuned AI/ML model is satisfactory.
14. Model transfer/delivery—The UE A transfers/delivers the retuned AI/ML model, A.3, to the network 1. The UE optionally transfers/delivers, to the network 1, one of the following, which could be in a binary format: (1) its retuned model; (2) the delta between the original and retuned model; or (3) information required to reconstruct the retuned model, metadata; and a unique ID associated with its retuned model. The unique model ID (for Model A.3 in this example) is a globally unique ID to identify a model or the model represented by the original model and the delta or original model and information required to reconstruct the retuned model. This is part of the UE-side retuned model section.

Continuing from step 11 of FIG. 5, a second option is presented in FIG. 9, wherein the UE, or the network, transfers/delivers the model binary, at least to the OTT server 210, and optionally to the network.
12. Monitoring procedure—Once the retuned AI/ML model, A.3, has been selected, the monitoring procedure checks the performance of the retuned AI/ML model as in step 4 of FIGS. 3 and 4.
13. Evaluate performance—The AI/ML model's performance is evaluated by the network 1 against a standardized or network-configured KPI value to determine that the performance of the retuned AI/ML model is satisfactory.

A UE-side returned model is part of process 14, comprised of steps 14a, 14b, and 14c.
14. (a) Model transfer/delivery—The UE optionally transfers/delivers, to the OTT server 210, one of the following, which could be in a binary format: (1) its retuned model; (2) the delta between the original and retuned model; or (3) information required to reconstruct the retuned model, metadata; and a unique ID associated with its retuned model. The unique model ID (for Model A.3 in this example) is a globally unique ID to identify a model or the model represented by the original model and the delta or original model and information required to reconstruct the retuned model.

(i) In another embodiment, the network, instead of the UE, could transfer/deliver the model to the OTT server.
14. (b) Model metadata—The UE transfers/delivers the retuned AI/ML model ID, and optionally, if the retuned AI/ML model is located at an OTT server, the location of the OTT server where the model can be found.

It is noted that 14a and 14b are performed as part of a single process, as this process provides the AI/ML model (A.3) to the OTT server 210 (in 14a) but also indicates to the network the information needed by the network 1 for the network 1 to use when selecting that model for other UEs. See 18-2 in FIG. 12, and step 18a there, where the network 1 indicates to the UE B a model download command that would also contain the location of the OTT server where the model can be found.
14. (c) Model transfer/delivery—The UE optionally transfers/delivers one of the following, which could be in a binary format: (1) its retuned model; (2) the delta between the original and retuned model; or (3) information required to reconstruct the retuned model, metadata; and a unique ID associated with its retuned model. The unique model ID (for Model A.3 in this example) is a globally unique ID to identify a model or the model represented by the original model and the delta or original model and information required to reconstruct the retuned model. This is part of the UE-side retuned model section.

Continuing from step 11 of FIG. 6, the final monitoring phase is presented for the network-side AI/ML model retuning procedure in FIG. 10. Note that in this case, the network already has the retuned model since the NW performed the retuning, so a model transfer/delivery procedure is not necessary in this phase.
12. Monitoring procedure—Once the retuned AI/ML model, A.3, has been selected, the monitoring procedure checks the performance of the retuned AI/ML model as in step 4 FIGS. 3 and 4.
13. Evaluate performance—the network determines that the AI/ML model's performance meets of exceeds a standardized or network-configured KPI value.

These steps are simpler, compared to UE-side and OTT-side AI/ML model retuning, since the network and UE both have the model already.

Continuing from step 11 of FIG. 7, the final monitoring phase is presented for the OTT-side AI/ML model retuning procedure in FIG. 11.
12. Monitoring procedure—Once the retuned AI/ML model, A.3, has been selected, the monitoring procedure checks the performance of the retuned AI/ML model as in step 4 of FIGS. 3 and 4.
13. Evaluate performance—the network determines that the AI/ML model's performance meets of exceeds a standardized or network-configured KPI value.

Reference 14 refers to a procedure for an OTT-side retuned model, and comprises steps 14a, 14b, and 14c.
14. (a) Model metadata—The UE transfers the retuned AI/ML model ID, and optionally, e.g., if required, the location of the OTT server where the model can be found.
14. (b) (Option 1) Model transfer/delivery—The UE optionally transfers/delivers, to the network 1, one of the following, which could be in a binary format: (1) its retuned model; (2) the delta between the original and retuned model; or (3) information required to reconstruct the retuned model, metadata; and a unique ID associated with its retuned model. The unique model ID (for Model A.3 in this example) is a globally unique ID to identify a model or the model represented by the original model and the delta or original model and information required to reconstruct the retuned model.
14. (b) (Option 2) In another embodiment, the OTT server could transfer/deliver the retuned model. The OTT server 210 optionally transfers/delivers, to the network 1, one of the following, which could be in a binary format: (1) its retuned model; (2) the delta between the original and retuned model; or (3) information required to reconstruct the retuned model, metadata; and a unique ID associated with its retuned model. The unique model ID (for Model A.3 in this example) is a globally unique ID to identify a model or the model represented by the original model and the delta or original model and information required to reconstruct the retuned model.

An AI/ML model memory phase is now described. Now that the original AI/ML model has been retuned, made available to the UE, selected by the UE, monitored, determined to be well-performing, and its binary transferred/delivered to the network (FIG. 8, FIG. 9, FIG. 11) or to the OTT server (FIG. 9) or its ID and metadata transferred to the network (FIG. 9, FIG. 11), the network can store, alongside the AI/ML model binary, model ID, and/or model metadata, information related to the conditions (e.g., channel conditions, network loading, time of day, and the like) under which the model is to be used and would perform well. These conditions can be used to help UEs not part of the AI/ML model retuning procedures described herein to acquire and execute the retuned AI/ML model for the best performance.

Additionally, the retuned model binaries, model IDs, model metadata, and/or information related to the conditions could be transferred/delivered between network entities (e.g., gNodeBs, LMFs, OTT servers, and other core network and OAM entities) when it is found that the retuned model could perform well in other areas or cases (e.g., gNodeB sectors, geographical areas, typical channel conditions).

The nature of the categorizations or definition of conditions is left out of scope for this document.

The AI/ML model distribution phase is now described. So far, in steps 1-14, a procedure has been described to detect a poorly performing model, execute an AI/ML model retuning procedure, evaluate the performance of the retuned AI/ML model, and store, along with conditions related to the scenario(s) in which the model will perform well, the model in a location form which UEs could obtain or be provided the retuned AI/ML model. This part describes the steps for UEs that were part of the initial monitoring phase and for future UEs to acquire the stored model.

The following steps, shown in FIG. 12, describe how to distribute the retuned AI/ML model, A.3, to another UE, UE B, which was part of the initial set of UEs being monitored (e.g., FIG. 4, steps 4-7):

This part assumes the network 1 has the model, indicated by reference 18-1, which is a procedure with steps 18a and 18b.
15. Model Monitoring-Either the network, the UE, or a combination of both (referred to as “hybrid”) monitors the performance of the AI/ML model. In the case of network-based or hybrid monitoring, the monitoring result is available at the network, and in the case of UE-based monitoring, the monitoring result is signaled from the UE to the network.
16. Evaluate Performance—the network determines an AI/ML model's performance falls below a standardized or network-configured KPI value.
17. Search Retuned Model memory (e.g., model memory 220)—the network searches for a suitable model, e.g., a previously retuned model, and finds (in this example) retuned AI/ML model A.3 230-3.
18. (a) Model transfer/delivery—the network transfers/delivers AI/ML model A.3 230-3 to UE B.
18. (b) Model transfer/delivery complete-UE B confirms that the transfer/delivery of AI/ML model A.3 230-3 is successful.
19. Model switch-UE B switches to model A.3 230-3.

This part assumes the OTT server 210 has the model, indicated by reference 18-2, which is a procedure with steps 18a, 18b, 18c, and 18d.
15. Model Monitoring-Either the network, the UE, or a combination of both (hybrid) monitors the performance of the AI/ML model. In the case of network-based or hybrid monitoring, the monitoring result is available at the network, and in the case of UE-based monitoring, the monitoring result is signaled from the UE to the network.
16. Evaluate Performance—the network determines an AI/ML model's performance falls below a standardized or network-configured KPI value.
17. Search Retuned Model memory—the network searches for a suitable model, e.g., a previously retuned model, and finds retuned AI/ML model A.3.
18. (a) Model download command-Using the model ID, and optionally the location of the model (OTT server), the network commands the UE to download the retuned AI/ML model, A.3.
18. (b) Model download—the UE requests to download the retuned AI/ML model, A.3, from the OTT server.
18. (c) Model transfer/delivery—the OTT server transfers/delivers the retuned AI/ML model, A.3, to UE B
18. (d) Model download complete-UE B confirms that the download of AI/ML model, A.3, is successful.
19. Model switch-UE B switches to model A.3.

One of the technical effects or advantages of the examples is to increase efficiency, and one example of this is when the AI/ML model, which was retuned in one entity, using data from one or more UEs, needs to be distributed to the other UEs which were not performing well with the original AI/ML model.

Another example is when UE A has the model. For brevity, this option has not been included in the call flow diagrams. This option would be for UE A, which has the retuned AI/ML model, A.3, from having completed steps 1-14 in the previous figures, to transfer/deliver its model to UE B over sidelink.

Note that there is no restriction on other UEs acquiring or being provided AI/ML models, either original or retuned, through a model selection procedure based on the network's recommendation. For example, note in step 6 in FIGS. 3 and 4, that the network first checks whether there is a suitable model, which could be used in lieu of retuning the AI/ML model, A.1. If the network determines that there is a suitable AI/ML model, then the following steps could be taken to configure the UE to use the more suitable AI/ML model.

The following steps apply when the UE does not have the model.

Steps 1-6 (see FIG. 3)—Perform the capability exchange; configure Functionality A; select AI/ML model A.1; through monitoring, determine that performance of AI/ML model A.1 is poor; search for a suitable AI/ML model.

Now, because the network knows of a suitable AI/ML, step 6 (search returned model memory) will return True, with the result AI/ML model A.3.

A new step is introduced here to query the UE as to whether the UE has the model.

The following describes what might happen when the UE does not have the model. If the UE responds that it does not have the model, the following steps can be performed:

Steps 15-18 (FIG. 12)—because the UE does not have the AI/ML model, the network facilitates the transfer/delivery of AI/ML model A.3 from the network or from the OTT server to the UE. Then the UE switches to AI/ML model A.3.

The following describes what might happen when the UE has the model. If the UE responds that it has the model, then the following steps can be performed:

Steps 16, 17 and 19 (FIG. 12)—Because the UE has AI/ML model A.3, the UE switches to AI/ML model A.3. That is, the UE could already have the model and could be queried as to whether the UE does have the model, and if so, switch to the model.

Turning to FIG. 13, this figure shows a block diagram of one possible and non-limiting example of a cellular network 1 that is connected to a user equipment (UE) 10. Multiple network elements are shown in the cellular network of FIG. 13: a base station 70; and a core network 90. An OTT server 210 is also shown. The OTT server 210 could be deployed inside an operator's network (e.g., in the core network 90 as OTT server 210-2) or externally, accessible over the internet (as shown in FIG. 13, when the data network 91 is the internet, as OTT server 210-1), or through a secure connection to the operator's network such as via a connection 3-1 to the data network 91 or via a more “direct” connection 3-2 coupling the OTT server 210-1 and the core network 90. The OTT server 210 is a server that is not part of the 3GPP system, i.e., a proprietary type of server, though the server might have 3GPP-facing interfaces. One part of the core network is the LMF 99-1, which is one of the network functions (NFs) 99, and which is described herein as being useful for the use case of UE location determination.

For terminology, a “network entity” includes both network elements that are in the network 1 (such as the base station 70 and the core network 90 or function/part thereof), and elements that can connect to the network, such as UE 10 and the OTT server 210 when the OTT server 210 is outside the network 1. In this way, the retuning can be performed by a network entity of a UE in FIG. 5, a network entity of a network element in FIG. 6, and a network entity of the OTT server in FIG. 7.

In FIG. 13, a user equipment (UE) 10 is in wireless communication via radio link 11 with the base station 70 of the cellular network 1. A UE 10 is a wireless communication device, such as a mobile device, that is configured to access a cellular network. The UE 10 is illustrated with one or more antennas 28. The ellipses 2 indicate there could be multiple UEs 10 in wireless communication via radio links with the base station 70. The UE 10 includes one or more processors 13, one or more memories 15, and other circuitry 16. The other circuitry 16 includes one or more receivers (Rx(s)) 17 and one or more transmitters (Tx(s)) 18. A program 12 is used to cause the UE 10 to perform the operations described herein. For a UE 10, the other circuitry 16 could include circuitry such as for user interface elements (not shown) like a display.

The base station 70, as a network element of the cellular network 1, provides the UE 10 access to cellular network 1 and to the data network 91 via the core network 90 (e.g., via a user plane function (UPF) of the core network 90). The base station 70 is illustrated as having one or more antennas 58. In general, the base station 70 may be referred to as RAN node 70, although many will make reference to this as a gNB (gNode B, a base station for NR, new radio) instead. There are, however, many other examples of RAN nodes including an eNB (evolved Node B) or TRP (Transmission-Reception Point). The base station 70 includes one or more processors 73, one or more memories 75, and other circuitry 76. The other circuitry 76 includes one or more receivers (Rx(s)) 77 and one or more transmitters (Tx(s)) 78. A program 72 is used to cause the base station 70 to perform the operations described herein.

It is noted that the base station 70 may instead be implemented via other wireless technologies, such as Wi-Fi (a wireless networking protocol that devices use to communicate without direct cable connections). In the case of Wi-Fi or other wireless network 1, the link 11 could be characterized as a wireless link.

Two or more base stations 70 communicate using, e.g., link(s) 79. The link(s) 79 may be wired or wireless or both and may implement, e.g., an Xn interface for 5G (fifth generation), an X2 interface for LTE (Long Term Evolution), or other suitable interface for other standards.

The cellular network 1 may include a core network 90, as a third illustrated element or elements, that may include core network functionality, and which provide connectivity via a link or links 81 with a data network 91, such as a telephone network and/or a data communications network (e.g., the Internet). The core network 90 includes one or more processors 93, one or more memories 95, and other circuitry 96. The other circuitry 96 includes one or more receivers (Rx(s)) 97 and one or more transmitters (Tx(s)) 98. A program 92 is used to cause the core network 90 to perform the operations described herein.

The core network 90 could be a 5GC (5G core network). The core network 90 can implement or comprise multiple network functions (NF(s)) 99, and the program 92 may comprise one or more of the NFs 99. A 5G core network may use hardware such as memory and processors and a virtualization layer. It could be a single standalone computing system, a distributed computing system, or a cloud computing system. The NFs 99, as network elements, of the core network could be containers or virtual machines running on the hardware of the computing system(s) making up the core network 90.

Core network functionality for 5G may include access and mobility management functionality that is provided by a network function 99 such as an access and mobility management function (AMF(s)), session management functionality that is provided by a network function such as a session management function (SMF). Core network functionality for access and mobility management in an LTE (Long Term Evolution) network may be provided by an MME (Mobility Management Entity) and/or SGW (Serving Gateway) functionality, which routes data to the data network. Many others are possible, as illustrated by the examples in FIG. 13: AMF; SMF; MME; SGW; GMLC (Gateway Mobile Location Center); LMFs (Location Management Functions); UDM (Unified Data Management)/UDR (Unified Data Repository); NRF (Network Repository Function); and/or E-SMLC (Evolved Serving Mobile Location Center). These are merely exemplary core network functionality that may be provided by the core network 90, and note that both 5G and LTE core network functionality might be provided by the core network 90. The RAN node 70 is coupled via a backhaul link 31 to the core network 90. The RAN node 70 and the core network 90 may include an NG (Next Generation) interface for 5G, or an SI interface for LTE, or other suitable interface for other radio access technologies for communicating via the backhaul link 31.

In the data network 91, there is a computer-readable medium 94. The computer-readable medium 94 contains instructions that, when downloaded and installed into the memories 15, 75, or 95 of the corresponding UE 10, base station 70, and/or core network element(s) 90, and executed by processor(s) 13, 73, or 93, cause the respective device to perform corresponding actions described herein. The computer-readable medium 94 may be implemented in other forms, such as via a compact disc or memory stick.

The programs 12, 72, and 92 contain instructions stored by corresponding one or more memories 15, 75, or 95. These instructions, when executed by the corresponding one or more processors 13, 73, or 93, cause the corresponding apparatus 10, 70, or 90, to perform the operations described herein. The computer readable memories 15, 75, or 95 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 15, 75, and 95 may be means for performing storage functions. The processors 13, 73, and 93, may be of any type suitable to the local technical environment, and may include one or more of general-purpose computers, special purpose computers, microprocessors, digital signal processors (DSPs) and processors based on a multi-core processor architecture, as non-limiting examples. The processors 13, 73, and 93 may be means for causing their respective apparatus to perform functions, such as those described herein.

The receivers 17, 77, and 97, and the transmitters 18, 78, and 98 may implement wired or wireless interfaces. The receivers and transmitters may be grouped together as transceivers.

The cellular network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities (such as network functions 99) that result from the network virtualization are still implemented, at some level, using hardware such as processors 73 and/or 93 and memories 75 and/or 95, and also such virtualized entities create technical effects.

In general, the various embodiments of the user equipment 10 can include, but are not limited to, cellular telephones (such as smart phones, mobile phones, cellular phones, voice over Internet Protocol (IP) (VOIP) phones, and/or wireless local loop phones), tablets, portable computers, vehicles or vehicle-mounted devices for, e.g., wireless V2X (vehicle-to-everything) communication, image capture devices such as digital cameras, gaming devices, music storage and playback appliances, Internet appliances (including Internet of Things, IoT, devices), IoT devices with sensors and/or actuators for, e.g., automation applications, as well as portable units or terminals that incorporate combinations of such functions, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. That is, the UE 10 could be any end device that may be capable of wireless communication. By way of example rather than limitation, the UE may also be referred to as a communication device, terminal device (MT), a Subscriber Station (SS), a Portable Subscriber Station, a Mobile Station (MS), or an Access Terminal (AT).

Without in any way limiting the scope, interpretation, or application of the claims appearing below, a technical effect and/or advantage of one or more of the example embodiments disclosed herein is the minimization of excess similar models by simultaneously considering many UEs operating the same poorly performing model and performing a single retuning operation, which could involve one or more UEs, to produce a single retuned model that all the UEs can use. Another technical effect and/or advantage of one or more of the example embodiments disclosed herein is that UEs operating the same base model as prior UEs that performed poorly can take advantage of the retuned model instead of producing additional, new, retuned versions of the same base model.

The following are additional examples.

Example 1. A method, comprising: evaluating, by a network element in a wireless network, performance of a first artificial intelligence or machine learning model being used by a user equipment in the wireless network; sending, by the network element based on the evaluation, configuration to a network entity involved in performing model retuning of the first artificial intelligence or machine learning model to aid in the model retuning; monitoring and evaluating performance, by the network element, of a second artificial intelligence or machine learning model that is a retuned version of the first artificial intelligence or machine learning model, wherein the first and second artificial intelligence or machine learning models are from a same lineage of artificial intelligence or machine learning models; and storing, by the network element in response to the evaluation of the second artificial intelligence or machine learning model, the second artificial intelligence or machine learning model for use by other user equipment.

Example 2. The method according to example 1, further comprising: performing, by the network element, monitoring and evaluating performance of the first artificial intelligence or machine learning model being used by a second user equipment; determining, by the network element based on the evaluating performance, to use the second artificial intelligence or machine learning model instead of the first artificial intelligence or machine learning model for the second user equipment; and sending, by the network element, a transfer of the second artificial intelligence or machine learning model to the second user equipment for use by the second user equipment.

Example 3. The method according to any of examples 1 or 2, wherein the sending configuration to the network entity comprises: sending configuration for model retuning to trigger the user equipment to perform operations to aid in retuning of the first artificial intelligence or machine learning model.

Example 4. The method according to example 3, wherein: the method further comprises receiving, by the network element, multiple indications indicating poor performance from multiple user equipment; the method further comprises deciding, by the network element, to change the first artificial intelligence or machine learning model based on reception of the multiple indications; and the sending configuration for model retuning to trigger the user equipment to perform operations to aid in retuning of the first artificial intelligence or machine learning model is performed in response to deciding to change the first artificial intelligence or machine learning model.

Example 5. The method according to example 3, wherein: the network entity comprises a user equipment; the configuration for model retuning triggers the user equipment to perform operations for performing retuning of the first artificial intelligence or machine learning model; and the sending configuration to the network entity further comprises sending configuration for data collection to the user equipment for retuning, to trigger the user equipment to collect data to aid in model retuning of the first artificial intelligence or machine learning model.

Example 6. The method according to example 5, wherein the method further comprises: receiving, by the network element from the user equipment, a transfer of the second artificial intelligence or machine learning model.

Example 7. The method according to example 5, wherein the method further comprises: receiving, by the network element from the user equipment, metadata for the second artificial intelligence or machine learning model, an indication of a unique identification for the second artificial intelligence or machine learning model, and a location where an over-the-top server, having the second artificial intelligence or machine learning model, can be found.

Example 8. The method according to example 3, wherein: the sending configuration to the network entity comprises sending configuration for data collection to the user equipment for retuning, to trigger the user equipment to collect data to aid in model retuning of the first artificial intelligence or machine learning model; the method further comprises: receiving, by the network element from the user equipment, measurement reports in response to the sent configuration for data collection to the user equipment for retuning; performing, by the network element, the retuning of the first artificial intelligence or machine learning model to form the second artificial intelligence or machine learning model; and performing, by the network element, a transfer of the second artificial intelligence or machine learning model to the user equipment.

Example 9. The method according to example 3, wherein: the sending configuration to the network entity comprises sending configuration for data collection to the user equipment for retuning, to trigger the user equipment to collect data to aid in model retuning of the first artificial intelligence or machine learning model; the method further comprises: receiving, by the network element from the user equipment, measurement reports in response to the sent configuration for data collection; and sending, by the network element, the measurement reports to an over-the-top server.

Example 10. The method according to example 9, further comprising one of the following: receiving, by the network element from the user equipment, metadata for the second artificial intelligence or machine learning model, an indication of a unique identification for the second artificial intelligence or machine learning model, and a location where an over-the-top server, having the second artificial intelligence or machine learning model, can be found; receiving, by the network element from the user equipment, a transfer of the second artificial intelligence or machine learning model; or receiving, by the network element from the over-the-top server, a transfer of the second artificial intelligence or machine learning model.

Example 11. The method according to example 1, further comprising: performing, by the network element to another user equipment, a transfer of the second artificial intelligence or machine learning model.

Example 12. The method according to example 1, further comprising: sending, by the network element to another user equipment, a command for the other user equipment to download the second artificial intelligence or machine learning model from an over-the-top server.

Example 13. The method according to any of the examples above, wherein each artificial intelligence or machine learning model has a globally unique identification that uniquely identifies that artificial intelligence or machine learning model from other artificial intelligence or machine learning models in the wireless network.

Example 14. The method according to any of examples 2, 6, 10, or 11, wherein a transfer of the second artificial intelligence or machine learning model comprises one of the following: (1) the second artificial intelligence or machine learning model; (2) a delta between the first and second artificial intelligence or machine learning model; or (3) information required to reconstruct the second artificial intelligence or machine learning model, metadata; and a unique identification associated with the second artificial intelligence or machine learning model.

Example 15. A method, comprising: receiving, by a user equipment in a wireless network from a network element in the wireless network, configuration indicating the user equipment is to aid in performing retuning of a first artificial intelligence or machine learning model being used by the user equipment; performing, by the user equipment, one or more operations to aid in the performing retuning of the first artificial intelligence or machine learning model, wherein the retuning creates a second artificial intelligence or machine learning model that is a retuned version of the first artificial intelligence or machine learning model, wherein the first and second artificial intelligence or machine learning models are from a same lineage of artificial intelligence or machine learning models; and switching by the user equipment from the first artificial intelligence or machine learning model to the second artificial intelligence or machine learning model.

Example 16. The method according to example 15, further comprising: prior to the switching, receiving, by the user equipment from the network element, a transfer of the second artificial intelligence or machine learning model.

Example 17. The method according to example 15, wherein: the configuration indicates the user equipment is to perform operations to perform retuning of the first artificial intelligence or machine learning model; the method further comprises: receiving, by the user equipment from the network element, configuration for data collection for retuning to trigger the user equipment to collect data to aid in model retuning of the first artificial intelligence or machine learning model.

retuning, by the user equipment, the first artificial intelligence or machine learning model to create the second artificial intelligence or machine learning model; and selecting, by the user equipment, the second artificial intelligence or machine learning model to use.

Example 18. The method according to example 17, wherein the method further comprises: sending, by the user equipment toward the network element, a transfer of the second artificial intelligence or machine learning model.

Example 19. The method according to example 17, wherein the method further comprises: sending, by the user equipment toward the network element, metadata for the second artificial intelligence or machine learning model, an indication of a unique identification for the second artificial intelligence or machine learning model, and a location where an over-the-top server, having the second artificial intelligence or machine learning model, can be found.

Example 20. The method according to example 15, wherein: the receiving configuration comprises receiving configuration for data collection for retuning, to trigger the user equipment to collect data to aid in model retuning of the first artificial intelligence or machine learning model; the method further comprises: sending, by the user equipment to the network element, measurement reports in response to the received configuration for data collection; receiving, by the user equipment from the network element, a transfer of the second artificial intelligence or machine learning model; and selecting, by the user equipment, the second artificial intelligence or machine learning model for use.

Example 21. The method according to example 15, wherein: the receiving configuration comprises receiving configuration for data collection for retuning, to trigger the user equipment to collect data to aid in model retuning of the first artificial intelligence or machine learning model; the method further comprises: sending, by the user equipment toward the network element, measurement reports in response to the received configuration for data collection for retuning; receiving, by the user equipment from an over-the-top server, a transfer of the second artificial intelligence or machine learning model; and selecting, by the user equipment, the second artificial intelligence or machine learning model for use.

Example 22. The method according to example 21, further comprising one of the following: sending, by the user equipment toward the network element, metadata for the second artificial intelligence or machine learning model, an indication of a unique identification for the second artificial intelligence or machine learning model, and a location where an over-the-top server, having the second artificial intelligence or machine learning model, can be found; or sending, by the user equipment toward the network element, a transfer of the second artificial intelligence or machine learning model.

Example 23. The method according to any of examples 15 to 22, wherein each artificial intelligence or machine learning model has a globally unique identification that uniquely identifies that artificial intelligence or machine learning model from other artificial intelligence or machine learning models in the wireless network.

Example 24. The method according to any of examples 18, 21, or 22, wherein a transfer of the second artificial intelligence or machine learning model comprises one of the following: (1) the second artificial intelligence or machine learning model; (2) a delta between the first and second artificial intelligence or machine learning model; or (3) information required to reconstruct the second artificial intelligence or machine learning model, metadata; and a unique identification associated with the second artificial intelligence or machine learning model.

Example 25. A computer program, comprising instructions for performing the methods of any of examples 1 to 24, when the computer program is run on an apparatus.

Example 26. The computer program according to example 25, wherein the computer program is a computer program product comprising a computer-readable medium bearing instructions embodied therein for use with the apparatus.

Example 27. The computer program according to example 25, wherein the computer program is directly loadable into an internal memory of the apparatus.

Example 28. An apparatus comprising means for performing: evaluating, by a network element in a wireless network, performance of a first artificial intelligence or machine learning model being used by a user equipment in the wireless network; sending, by the network element based on the evaluation, configuration to a network entity involved in performing model retuning of the first artificial intelligence or machine learning model to aid in the model retuning; monitoring and evaluating performance, by the network element, of a second artificial intelligence or machine learning model that is a retuned version of the first artificial intelligence or machine learning model, wherein the first and second artificial intelligence or machine learning models are from a same lineage of artificial intelligence or machine learning models; and storing, by the network element in response to the evaluation of the second artificial intelligence or machine learning model, the second artificial intelligence or machine learning model for use by other user equipment.

Example 29. The apparatus according to example 28, wherein the means are further configured to perform: performing, by the network element, monitoring and evaluating performance of the first artificial intelligence or machine learning model being used by a second user equipment; determining, by the network element based on the evaluating performance, to use the second artificial intelligence or machine learning model instead of the first artificial intelligence or machine learning model for the second user equipment; and sending, by the network element, a transfer of the second artificial intelligence or machine learning model to the second user equipment for use by the second user equipment.

Example 30. The apparatus according to any of examples 28 or 29, wherein the sending configuration to the network entity comprises: sending configuration for model retuning to trigger the user equipment to perform operations to aid in retuning of the first artificial intelligence or machine learning model.

Example 31. The apparatus according to example 30, wherein: the means are further configured to perform: receiving, by the network element, multiple indications indicating poor performance from multiple user equipment; the means are further configured to perform: deciding, by the network element, to change the first artificial intelligence or machine learning model based on reception of the multiple indications; and the sending configuration for model retuning to trigger the user equipment to perform operations to aid in retuning of the first artificial intelligence or machine learning model is performed in response to deciding to change the first artificial intelligence or machine learning model.

Example 32. The apparatus according to example 30, wherein: the network entity comprises a user equipment; the configuration for model retuning triggers the user equipment to perform operations for performing retuning of the first artificial intelligence or machine learning model; and the sending configuration to the network entity further comprises sending configuration for data collection to the user equipment for retuning, to trigger the user equipment to collect data to aid in model retuning of the first artificial intelligence or machine learning model.

Example 33. The apparatus according to example 32, wherein the means are further configured to perform: receiving, by the network element from the user equipment, a transfer of the second artificial intelligence or machine learning model.

Example 34. The apparatus according to example 32, wherein the means are further configured to perform: receiving, by the network element from the user equipment, metadata for the second artificial intelligence or machine learning model, an indication of a unique identification for the second artificial intelligence or machine learning model, and a location where an over-the-top server, having the second artificial intelligence or machine learning model, can be found.

Example 35. The apparatus according to example 30, wherein: the sending configuration to the network entity comprises sending configuration for data collection to the user equipment for retuning, to trigger the user equipment to collect data to aid in model retuning of the first artificial intelligence or machine learning model; the means are further configured to perform: receiving, by the network element from the user equipment, measurement reports in response to the sent configuration for data collection to the user equipment for retuning; performing, by the network element, the retuning of the first artificial intelligence or machine learning model to form the second artificial intelligence or machine learning model; and performing, by the network element, a transfer of the second artificial intelligence or machine learning model to the user equipment.

Example 36. The apparatus according to example 30, wherein: the sending configuration to the network entity comprises sending configuration for data collection to the user equipment for retuning, to trigger the user equipment to collect data to aid in model retuning of the first artificial intelligence or machine learning model; the means are further configured to perform: receiving, by the network element from the user equipment, measurement reports in response to the sent configuration for data collection; and sending, by the network element, the measurement reports to an over-the-top server.

Example 37. The apparatus according to example 36, wherein the means are further configured to perform one of the following: receiving, by the network element from the user equipment, metadata for the second artificial intelligence or machine learning model, an indication of a unique identification for the second artificial intelligence or machine learning model, and a location where an over-the-top server, having the second artificial intelligence or machine learning model, can be found; receiving, by the network element from the user equipment, a transfer of the second artificial intelligence or machine learning model; or receiving, by the network element from the over-the-top server, a transfer of the second artificial intelligence or machine learning model.

Example 38. The apparatus according to example 28, wherein the means are further configured to perform: performing, by the network element to another user equipment, a transfer of the second artificial intelligence or machine learning model.

Example 39. The apparatus according to example 28, wherein the means are further configured to perform: sending, by the network element to another user equipment, a command for the other user equipment to download the second artificial intelligence or machine learning model from an over-the-top server.

Example 40. The apparatus according to any of examples 28 to 39 wherein each artificial intelligence or machine learning model has a globally unique identification that uniquely identifies that artificial intelligence or machine learning model from other artificial intelligence or machine learning models in the wireless network.

Example 41. The apparatus according to any of examples 29, 33, 37, or 38, wherein a transfer of the second artificial intelligence or machine learning model comprises one of the following: (1) the second artificial intelligence or machine learning model; (2) a delta between the first and second artificial intelligence or machine learning model; or (3) information required to reconstruct the second artificial intelligence or machine learning model, metadata; and a unique identification associated with the second artificial intelligence or machine learning model.

Example 42. An apparatus comprising means for performing: receiving, by a user equipment in a wireless network from a network element in the wireless network, configuration indicating the user equipment is to aid in performing retuning of a first artificial intelligence or machine learning model being used by the user equipment; performing, by the user equipment, one or more operations to aid in the performing retuning of the first artificial intelligence or machine learning model, wherein the retuning creates a second artificial intelligence or machine learning model that is a retuned version of the first artificial intelligence or machine learning model, wherein the first and second artificial intelligence or machine learning models are from a same lineage of artificial intelligence or machine learning models; and switching by the user equipment from the first artificial intelligence or machine learning model to the second artificial intelligence or machine learning model.

Example 43. The apparatus according to example 42, wherein the means are further configured to perform: prior to the switching, receiving, by the user equipment from the network element, a transfer of the second artificial intelligence or machine learning model.

Example 44. The apparatus according to example 42, wherein: the configuration indicates the user equipment is to perform operations to perform retuning of the first artificial intelligence or machine learning model; the means are further configured to perform: receiving, by the user equipment from the network element, configuration for data collection for retuning to trigger the user equipment to collect data to aid in model retuning of the first artificial intelligence or machine learning model.

retuning, by the user equipment, the first artificial intelligence or machine learning model to create the second artificial intelligence or machine learning model; and selecting, by the user equipment, the second artificial intelligence or machine learning model to use.

Example 45. The apparatus according to example 44, wherein the means are further configured to perform: sending, by the user equipment toward the network element, a transfer of the second artificial intelligence or machine learning model.

Example 46. The apparatus according to example 44, wherein the means are further configured to perform: sending, by the user equipment toward the network element, metadata for the second artificial intelligence or machine learning model, an indication of a unique identification for the second artificial intelligence or machine learning model, and a location where an over-the-top server, having the second artificial intelligence or machine learning model, can be found.

Example 47. The apparatus according to example 42, wherein: the receiving configuration comprises receiving configuration for data collection for retuning, to trigger the user equipment to collect data to aid in model retuning of the first artificial intelligence or machine learning model; the means are further configured to perform: sending, by the user equipment to the network element, measurement reports in response to the received configuration for data collection; receiving, by the user equipment from the network element, a transfer of the second artificial intelligence or machine learning model; and selecting, by the user equipment, the second artificial intelligence or machine learning model for use.

Example 48. The apparatus according to example 42, wherein: the receiving configuration comprises receiving configuration for data collection for retuning, to trigger the user equipment to collect data to aid in model retuning of the first artificial intelligence or machine learning model; the means are further configured to perform: sending, by the user equipment toward the network element, measurement reports in response to the received configuration for data collection for retuning; receiving, by the user equipment from an over-the-top server, a transfer of the second artificial intelligence or machine learning model; and selecting, by the user equipment, the second artificial intelligence or machine learning model for use.

Example 49. The apparatus according to example 48, wherein the means are further configured to perform one of the following: sending, by the user equipment toward the network element, metadata for the second artificial intelligence or machine learning model, an indication of a unique identification for the second artificial intelligence or machine learning model, and a location where an over-the-top server, having the second artificial intelligence or machine learning model, can be found; or sending, by the user equipment toward the network element, a transfer of the second artificial intelligence or machine learning model.

Example 50. The apparatus according to any of examples 42 to 49, wherein each artificial intelligence or machine learning model has a globally unique identification that uniquely identifies that artificial intelligence or machine learning model from other artificial intelligence or machine learning models in the wireless network.

Example 51. The apparatus according to any of examples 45, 48, or 49, wherein a transfer of the second artificial intelligence or machine learning model comprises one of the following: (1) the second artificial intelligence or machine learning model; (2) a delta between the first and second artificial intelligence or machine learning model; or (3) information required to reconstruct the second artificial intelligence or machine learning model, metadata; and a unique identification associated with the second artificial intelligence or machine learning model.

Example 52. The apparatus of any preceding apparatus example, wherein the means comprises: at least one processor; and at least one memory storing instructions that, when executed by at least one processor, cause the performance of the apparatus.

Example 53. An apparatus, comprising: one or more processors; and one or more memories storing instructions that, when executed by the one or more processors, cause the apparatus at least to perform: evaluating, by a network element in a wireless network, performance of a first artificial intelligence or machine learning model being used by a user equipment in the wireless network; sending, by the network element based on the evaluation, configuration to a network entity involved in performing model retuning of the first artificial intelligence or machine learning model to aid in the model retuning; monitoring and evaluating performance, by the network element, of a second artificial intelligence or machine learning model that is a retuned version of the first artificial intelligence or machine learning model, wherein the first and second artificial intelligence or machine learning models are from a same lineage of artificial intelligence or machine learning models; and storing, by the network element in response to the evaluation of the second artificial intelligence or machine learning model, the second artificial intelligence or machine learning model for use by other user equipment.

Example 53a. The apparatus of example 53, wherein the one or more memories further store instructions that, when executed by the one or more processors, cause the apparatus at least to perform any of the methods of claims 2 to 14.

Example 54. An apparatus, comprising: one or more processors; and one or more memories storing instructions that, when executed by the one or more processors, cause the apparatus at least to perform: receiving, by a user equipment in a wireless network from a network element in the wireless network, configuration indicating the user equipment is to aid in performing retuning of a first artificial intelligence or machine learning model being used by the user equipment; performing, by the user equipment, one or more operations to aid in the performing retuning of the first artificial intelligence or machine learning model, wherein the retuning creates a second artificial intelligence or machine learning model that is a retuned version of the first artificial intelligence or machine learning model, wherein the first and second artificial intelligence or machine learning models are from a same lineage of artificial intelligence or machine learning models; and switching by the user equipment from the first artificial intelligence or machine learning model to the second artificial intelligence or machine learning model.

Example 54a. The apparatus of example 54, wherein the one or more memories further store instructions that, when executed by the one or more processors, cause the apparatus at least to perform any of the methods of claims 16 to 24.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 13. A computer-readable medium may comprise a computer-readable storage medium (e.g., memories 15, 75, and 95 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3GPP third generation partnership project
5G fifth generation
AI Artificial Intelligence
AI/ML or AI/ML Artificial intelligence/machine learning
AMF access and mobility management function
AUC Area under the ROC Curve
BLER Block Error Rate
BM beam management
CI confidence interval
CSI channel state information
E-SMLC evolved serving mobile location center
eNB (or eNodeB) evolved Node B (e.g., an LTE base station)
FFS for future study
FG feature group
GMLC Gateway Mobile Location Center
gNB (or gNodeB) base station for 5G/NR
GNSS global navigation satellite system
ID identification
I/F interface
IP Internet protocol
KPI key performance indicator
LCM Lifecycle Management
LMF Location Management Function
LPP LTE positioning protocol
LTE long term evolution
ML machine learning
MME mobility management entity
NAS non-access stratum
NF network function
ng or NG next generation
NR new radio
NRF Network Repository Function
N/W or NW network
OAM operations and maintenance
OTT Over The Top
PRS positioning reference signal (or symbol)
RAN radio access network
RAT radio access technology
Rel release
RRC radio resource control
RS reference signal
Rx receiver
SGCS Squared Generalized Cosine Similarity
SGW serving gateway
SMF session management function
TCE Trace Collection Entity
TCI Transmission Configuration Indication
TRP transmission-reception point
Tx transmitter
UDM unified data management
UDR unified data repository
UE user equipment (e.g., a wireless, typically mobile device)
UPF user plane function

1.-54. (canceled)

55. An apparatus comprising:
a processor; and
a memory comprising computer-executable instructions that, when executed by the processor, cause the apparatus at least to perform:
based on a determination that a performance of a first artificial intelligence model falls below a quality threshold value and that no other accessible artificial intelligence model is suitable, receiving, in a wireless network from a network element in the wireless network, configuration indicating the apparatus is to aid in performing retuning of the first artificial intelligence model being used by the apparatus;
receiving, from the network element, configuration for data collection for retuning to trigger apparatus to collect data to aid in model retuning of the first artificial intelligence model;
based on the configuration, collecting measurements for the first artificial intelligence model, the measurements comprising: reference symbol measurements (e.g., CSI RS, PRS);
sensor measurements (e.g., barometric pressure, velocity, acceleration); and non-RAT measurements (e.g., GNSS location);
upon collecting a threshold amount sample measurements and a threshold amount of different types of measurements,
performing operations to aid in the performing retuning of the first artificial intelligence model, wherein the retuning creates a second artificial intelligence model that is a retuned version of the first artificial intelligence model, wherein the first and second artificial intelligence models are from a same lineage of artificial intelligence models;
using the collected measurements, retuning the first artificial intelligence model to create the second artificial intelligence model;
switching from the first artificial intelligence model to the second artificial intelligence model; and
sending, to the network element, the following in binary format: metadata for the second artificial intelligence model, an indication of a unique identification for the second artificial intelligence model, a delta between the first artificial intelligence model and the second artificial intelligence model, and information required to reconstruct the second artificial intelligence model.

56. The apparatus of claim 55, wherein the computer-executable instructions further cause the processor to perform the following operation:
prior to the switching, transferring the second artificial intelligence model to the network element.

57. The apparatus of claim 56, wherein the computer-executable instructions further cause the processor to perform the following operation:
based on the second artificial intelligence model passing quality thresholds, storing the second artificial intelligence model in a shared memory that enables other user equipment to access and use the second artificial intelligence model.

58. The apparatus of claim 57, wherein the first and second artificial intelligence models have a globally unique identification that uniquely identifies that artificial intelligence model from other artificial intelligence models in the wireless network.

59. The apparatus of claim 58, wherein the apparatus is a user equipment.

60. The apparatus of claim 59, wherein the second artificial intelligence model is transferred using a sidelink.

61. The apparatus of claim 60, wherein the computer-executable instructions further cause the processor to perform the following operations:
based on a determination that a performance of the second artificial intelligence model falls below the quality threshold value and that no other accessible artificial intelligence model is suitable, receiving, in the wireless network from the network element in the wireless network, configuration indicating the apparatus is to aid in performing retuning of the second artificial intelligence model being used by the apparatus.

62. An apparatus comprising:
a processor; and
a memory comprising computer-executable instructions that, when executed by the processor, cause the apparatus at least to perform:
based on a determination that a performance of a first machine learning model falls below a quality threshold value and that no other accessible machine learning model is suitable, receiving, in a wireless network from a network element in the wireless network, configuration indicating the apparatus is to aid in performing retuning of the first machine learning model being used by the apparatus;
receiving, from the network element, configuration for data collection for retuning to trigger apparatus to collect data to aid in model retuning of the first machine learning model;
based on the configuration, collecting measurements for the first machine learning model, the measurements comprising: reference symbol measurements (e.g., CSI RS, PRS); sensor measurements (e.g., barometric pressure, velocity, acceleration); and non-RAT measurements (e.g., GNSS location);
upon collecting a threshold amount sample measurements and a threshold amount of different types of measurements,
performing operations to aid in the performing retuning of the first machine learning model, wherein the retuning creates a second machine learning model that is a retuned version of the first machine learning model, wherein the first and second machine learning models are from a same lineage of machine learning models;
using the collected measurements, retuning the first machine learning model to create the second machine learning model;
switching from the first machine learning model to the second machine learning model; and
sending, to the network element, the following in binary format: metadata for the second machine learning model, an indication of a unique identification for the second machine learning model, a delta between the first machine learning model and the second machine learning model, and information required to reconstruct the second machine learning model.

63. The apparatus of claim 62, wherein the computer-executable instructions further cause the processor to perform the following operation:
prior to the switching, transferring the second machine learning model to the network element.

64. The apparatus of claim 63, wherein the computer-executable instructions further cause the processor to perform the following operation:
based on the second machine learning model passing quality thresholds, storing the second machine learning model in a shared memory that enables other user equipment to access and use the second machine learning model.

65. The apparatus of claim 64, wherein the first and second machine learning models have a globally unique identification that uniquely identifies that machine learning model from other machine learning models in the wireless network.

66. The apparatus of claim 65, wherein the apparatus is a user equipment.

67. The apparatus of claim 66, wherein the second machine learning model is transferred using a sidelink.

68. The apparatus of claim 67, wherein the computer-executable instructions further cause the processor to perform the following operations:
based on a determination that a performance of the second machine learning model falls below the quality threshold value and that no other accessible machine learning model is suitable, receiving, in the wireless network from the network element in the wireless network, configuration indicating the apparatus is to aid in performing retuning of the second machine learning model being used by the apparatus.

69. A system comprising:
an apparatus:
a processor; and
a memory comprising computer-executable instructions that, when executed by the processor, cause the apparatus at least to perform:
based on a determination that a performance of a first machine learning model falls below a quality threshold value and that no other accessible machine learning model is suitable, receiving, in a wireless network from a network element in the wireless network, configuration indicating the apparatus is to aid in performing retuning of the first machine learning model being used by the apparatus;
receiving, from the network element, configuration for data collection for retuning to trigger apparatus to collect data to aid in model retuning of the first machine learning model;
based on the configuration, collecting measurements for the first machine learning model, the measurements comprising: reference symbol measurements (e.g., CSI RS, PRS); sensor measurements (e.g., barometric pressure, velocity, acceleration); and non-RAT measurements (e.g., GNSS location);
upon collecting a threshold amount sample measurements and a threshold amount of different types of measurements,
performing operations to aid in the performing retuning of the first machine learning model, wherein the retuning creates a second machine learning model that is a retuned version of the first machine learning model, wherein the first and second machine learning models are from a same lineage of machine learning models;
using the collected measurements, retuning the first machine learning model to create the second machine learning model;
switching from the first machine learning model to the second machine learning model; and
sending, to the network element, the following in binary format: metadata for the second machine learning model, an indication of a unique identification for the second machine learning model, a delta between the first machine learning model and the second machine learning model, and information required to reconstruct the second machine learning model.

70. The system of claim 69, wherein the computer-executable instructions further cause the processor to perform the following operation:
prior to the switching, transferring the second machine learning model to the network element.

71. The system of claim 70, wherein the computer-executable instructions further cause the processor to perform the following operation:
based on the second machine learning model passing quality thresholds, storing the second machine learning model in a shared memory that enables other user equipment to access and use the second machine learning model.

72. The system of claim 71, wherein the first and second machine learning models have a globally unique identification that uniquely identifies that machine learning model from other machine learning models in the wireless network.

73. The system of claim 72, wherein the second machine learning model is transferred using a sidelink.

74. The system of claim 73, wherein the computer-executable instructions further cause the processor to perform the following operations:
based on a determination that a performance of the second machine learning model falls below the quality threshold value and that no other accessible machine learning model is suitable, receiving, in the wireless network from the network element in the wireless network, configuration indicating the apparatus is to aid in performing retuning of the second machine learning model being used by the apparatus.
